(19) United States
(12) Patent Application Publication
(10) Pub. No.: US 2017/0220314 A1
(43) Pub. Date: Aug. 3, 2017

(54) GROUP-VIEWING ASSISTANCE DEVICE, GROUP-VIEWING ASSISTANCE METHOD, AND VIEWING APPARATUS

(71) Applicant: SHARP KABUSHIKI KAISHA, Osaka (JP)

(72) Inventors: Takashi KANEKO, Sakai City (JP); Atsutoshi SHIMENO, Sakai City (JP); Chanbin NI, Sakai City (JP); Masahiro SHIOI, Sakai City (JP); Norio ITOH, Sakai City (JP)

(73) Assignee: SHARP KABUSHIKI KAISHA, Sakai City, Osaka (JP)

(21) Appl. No.: 15/501,362

(22) PCT Filed: Jul. 30, 2015
(86) PCT No.: PCT/JP2015/071683

§ 371 Date: Feb. 2, 2017

(30) Foreign Application Priority Data
Aug. 6, 2014 (JP) 2014-160770

(51) Int. Cl. G06F 3/14; H04N 21/482; H04N 21/4788; G06T 13/40

(52) U.S. Cl. CPC G06F 3/1454; G06F 3/1423; G06T 13/40; H04N 21/482; H04N 21/4788; G06F 3/0482

(57) ABSTRACT

A group-viewing assistance device allowing a viewer to perform group-viewing without giving much resistance is realized. A group-viewing assistance server (100) presents a viewing environment list indicating, for each group, which content is under group-viewing, executes processing for causing a person who desires group-viewing to participate in remote communication in a group designated by the desiring person, and causes a viewing apparatus (200) of the desiring person to reproduce a content under group-viewing by the group.

### TECHNICAL FIELD

The present invention relates to a group-viewing assistance device and a group-viewing assistance method that mainly assist a plurality of viewers in different places to perform group-viewing.

### BACKGROUND ART

In recent years, various techniques for realizing remote communication among a plurality of viewers in different places who are viewing the same program have been proposed.

For example, with use of the invention described in PTL 1, viewers who are viewing the same program are able to communicate with each other by participating chatting or in an electronic bulletin board.

A technique of PTL 2 is proposed for the purpose of solving a problem that “it is difficult for a viewer to find another viewer who has a topic or way of thinking similar to that of the viewer, so that it is hard for the viewer to perform good communication”.

A service management device of PTL 2 acquires viewing information that is information about a state of viewing when a viewer views a video content, determines a group, in which the viewer is able to participate, on the basis of the viewing information of the viewer, and notifies the viewer using a terminal device of a virtual communication space prepared for the determined group in which the viewer is able to participate.

### CITATION LIST

### Patent Literature

PTL 1: Japanese Unexamined Patent Application Publication No. 11-88863 (published on Mar. 30, 1999)

PTL 2: Japanese Unexamined Patent Application Publication No. 2006-108996 (published on Apr. 20, 2006)

### SUMMARY OF INVENTION

### Technical Problem

A viewer using the invention of PTL 2, in order to communicate about content of a program with a member of a group in which the viewer desires to participate, needs to perform both an operation for viewing the program and an operation for participating in the group (refer to paragraphs 0074, 0101, 0105, and the like of PTL 2). That is, the invention of PTL 2 has a problem that a viewer will find it a great bother to perform the operations and not positively participate in the group.

The invention of PTL 1 also has a similar problem to such problems.

The invention has been made in view of the aforementioned problems, and a main object thereof is to realize a group-viewing assistance device allowing a viewer to perform group-viewing without giving much resistance.

### Solution to Problem

A group-viewing assistance device according to an aspect of the invention is a group-viewing assistance device that provides a group-viewing service by which remote communication in a group is realized while a common content is viewed by individual viewing apparatuses, including: information presentation means that presents, to a viewing apparatus of a user, information indicating, for each group, which content is under group-viewing; execution means that executes processing for causing the user to participate in remote communication in a group designated by the user; and reproduction control means that controls the viewing apparatus of the user to reproduce a content under group-viewing by the designated group.

A group-viewing assistance method according to an aspect of the invention is a group-viewing assistance method by one or a plurality of devices used for providing a group-viewing service by which remote communication in a group is realized while a common content is viewed by individual viewing apparatuses, including the steps of: presenting, to a viewing apparatus of a user, information indicating, for each group, which content is under group-viewing; executing processing for causing the user to participate in remote communication in a group designated by the user; and controlling the viewing apparatus of the user to reproduce a content under group-viewing by the designated group.

### Advantageous Effects of Invention

A group-viewing assistance device and a group-viewing assistance method according to an aspect of the invention exert an effect of allowing a viewer to perform group-viewing without giving much resistance.

### BRIEF DESCRIPTION OF DRAWINGS

FIG. 1 is a block diagram of a group-viewing assistance server and a viewing apparatus that form a system according to Embodiment 1 of the invention.

FIG. 2 schematically illustrates various tables held by the group-viewing assistance server of FIG. 1.

FIG. 3 schematically illustrates a viewing environment information table held by the group-viewing assistance server of FIG. 1.

FIG. 4 schematically illustrates a launcher screen and a main screen (My House screen described later) of a group-viewing application that are displayed on the viewing apparatus of FIG. 1.

FIG. 5 is a sequence view illustrating an operation of the system according to Embodiment 1 when the group-viewing application starts and when it is terminated.

FIG. 6 illustrates a user setting screen displayed on the viewing apparatus of FIG. 1.

FIG. 7 is a sequence view illustrating an operation of the system according to Embodiment 1 when the viewing apparatus receives a specific operation (an operation to display a virtual map screen on the viewing apparatus).

FIG. 8 illustrates the virtual map screen displayed on the viewing apparatus of FIG. 1.

FIG. 9 is a sequence view illustrating an operation of the system according to Embodiment 1 when the viewing apparatus receives a different specific operation (an operation for a virtual map).

FIG. 10 is a view for explaining a change in the virtual map screen associated with the different specific operation.

FIG. 11 is another view for explaining a change in the virtual map screen associated with the different specific operation.

FIG. 12 is a sequence view illustrating an operation of the system according to Embodiment 1 when the viewing apparatus receives a still different specific operation (an operation to participate in group-viewing performed in a different house on the virtual map).

FIG. 13 illustrates a screen displayed on a viewing apparatus of a user who manages the different house.

FIG. 14 is a view for explaining another method of participating in group-viewing.

FIG. 15 illustrates a screen displayed on a viewing apparatus forming a system according to Embodiment 3 of the invention.

### DESCRIPTION OF EMBODIMENTS

### Embodiment 1

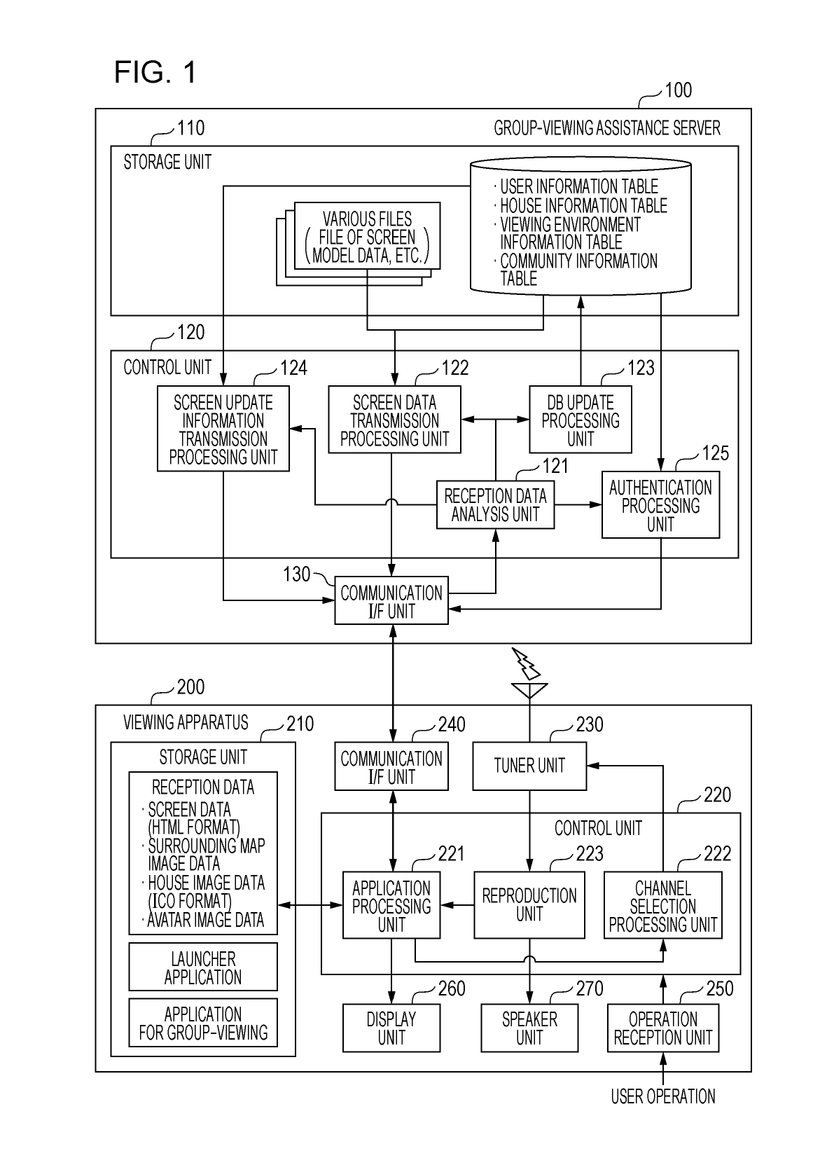

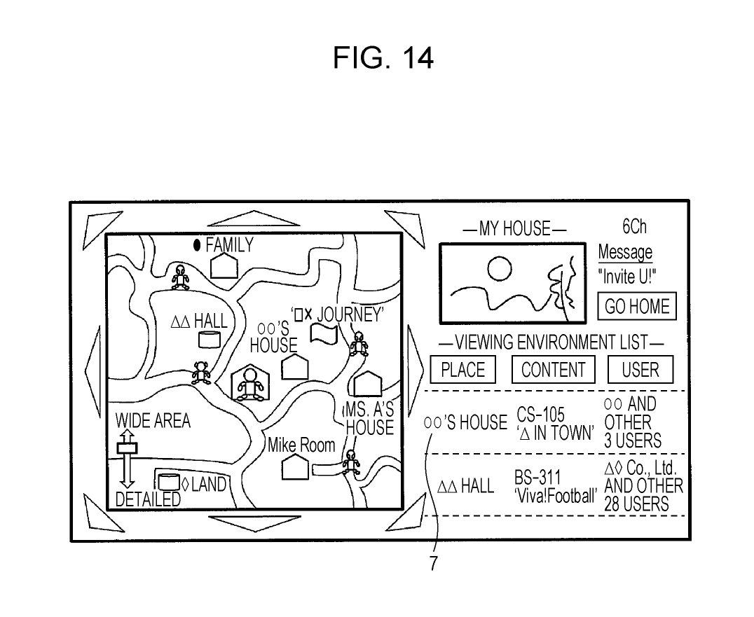

A system according to an embodiment of the invention will be described below with reference to FIGS. 1 to 14.

### (Outline of System According to Present Embodiment)

An outline of the system according to the present embodiment (hereinafter, simply referred to as a “system”) will be described with reference to FIG. 1. FIG. 1 is a block diagram of devices forming the system.

As illustrated in FIG. 1, the system includes a group-viewing assistance server 100 and a viewing apparatus 200.

The group-viewing assistance server 100 is a server used for providing a user with a service for assisting group-viewing (a viewing format in which remote communication is performed in a group while viewing a common content by individual viewing apparatuses).

The viewing apparatus 200 is a viewing apparatus on which a group-viewing application is installed. The viewing apparatus 200 executing the group-viewing application provides the user with a group-viewing service in cooperation with the group-viewing assistance server 100.

By performing an operation of designating a group, the user of the viewing apparatus 200 is able to participate in the designated group (that is, cause the viewing apparatus 200 to reproduce a content viewed by the group and perform text chatting about details of the content with a member of the group).

Note that, though the remote communication in the present embodiment is the text chatting, the remote communication may be voice chatting or other types of remote communication.

### (Configurations of Devices Included in System)

Next, configurations of the devices included in the system will be described with reference to FIG. 1 continuously.

### (Group-Viewing Assistance Server 100)

As illustrated in FIG. 1, the group-viewing assistance server 100 includes a storage unit 110, a control unit 120, and a communication I/F unit 130.

The storage unit 110 is a recording medium in which various data (a file of screen model data of each screen related to the group-viewing service, a user information table for managing information of users registered in the group-viewing service, and the like) related to the group-viewing service is stored. Here, the screen model data is data that is referred to for generating a screen according to the user by the group-viewing assistance server 100. Examples of the file of the screen model data include a file of an ASP (Active Server Page) format and a file of a PHP (Personal Home Page) format.

The control unit 120 is a CPU that integrally controls a whole of the group-viewing assistance server 100.

The control unit 120 functions as a reception data analysis unit 121, a screen data transmission processing unit 122, a DB update processing unit 123, a screen update information transmission processing unit 124, and an authentication processing unit 125 while the group-viewing assistance server 100 operates as a WEB server.

The reception data analysis unit 121 analyzes data transmitted by the group-viewing application to the group-viewing assistance server 100 to thereby specify what request is given from the group-viewing application.

The screen data transmission processing unit 122 generates data of a screen according to the user who possesses the viewing apparatus 200 in accordance with the request from the group-viewing application of the viewing apparatus 200, and transmits the generated data (for example, HTML data). Note that, as one of such screens, there is a virtual map screen.

The virtual map screen is a screen including a virtual map that indicates a part of a virtual world where characters of users of the group-viewing service live and a viewing environment list that indicates, for each group, what content is currently subjected to group-viewing. The characters of the users are able to move in the virtual world.

In the virtual world, a house where a character of a user lives is arranged for each of users. When the user moves his/her character to a house where a character of another user is, the user is able to perform group-viewing in a group gathering in the house. That is, it may be said that each group under group-viewing is linked to any point (for example, house) in the virtual world.

In accordance with the request from the group-viewing application, the DB update processing unit 123 updates various tables (for example, the aforementioned user information table and a viewing environment information table indicating a situation of group-viewing in the virtual world) in a database.

For example, in a case where it is decided that the user of the viewing apparatus 200 participates in remote communication (group-viewing) in the group designated by the user, the DB update processing unit 123 performs processing for updating the viewing environment information table as processing for making the user participate in the remote communication.

The screen update information transmission processing unit 124 transmits data for updating various screens displayed on the viewing apparatus 200. For example, in a case where another user of a group in which the user of the viewing apparatus 200 participates inputs a character string indicating his/her speech content, the screen update information transmission processing unit 124 transmits data indicating the character string to the viewing apparatus 200.

The authentication processing unit 125 executes log-in authentication processing in accordance with a log-in request to the group-viewing service from the viewing apparatus 200.

The communication I/F unit 130 is a communication interface provided to allow the group-viewing assistance server 100 to perform IP communicate with another apparatus.

### (Viewing Apparatus 200)

As illustrated in FIG. 1, the viewing apparatus 200 includes a storage unit 210, a control unit 220, a tuner unit 230, a communication I/F unit 240, an operation reception unit 250, a display unit 260, and a speaker unit 270.

The storage unit 210 is a recording medium on which the aforementioned group-viewing application, a launcher application, and the like are installed. Various data received from the group-viewing assistance server 100 is recorded in the storage unit 210.

The control unit 220 is a CPU that integrally controls a whole of the viewing apparatus 200.

The control unit 220 functions as an application processing unit 221, a channel selection processing unit 222, and a reproduction unit 223 by executing various programs (various programs including a program of the group-viewing application) installed on the storage unit 210.

The application processing unit 221 executes various processing associated with the group-viewing application. For example, the application processing unit 221 records data received from the group-viewing assistance server 100 in the storage unit 210 and executes processing according to details of the data.

The channel selection processing unit 222 executes channel selection processing in accordance with an instruction from the application processing unit 221.

The reproduction unit 223 reproduces a content received by the tuner unit 230.

The tuner unit 230 is a tuner that receives a broadcast signal including the content.

The communication I/F unit 240 is a communication interface provided to allow the viewing apparatus 200 to perform IP communicate with another apparatus.

The operation reception unit 250 is an input device that receives a user operation.

The display unit 260 is a display on which various screens (screens including a video of the content) of the group-viewing application are displayed.

The speaker unit 270 is a sound output device that outputs sound of the content.

As above, the configurations of the devices included in the system have been described.

### (About Various Tables)

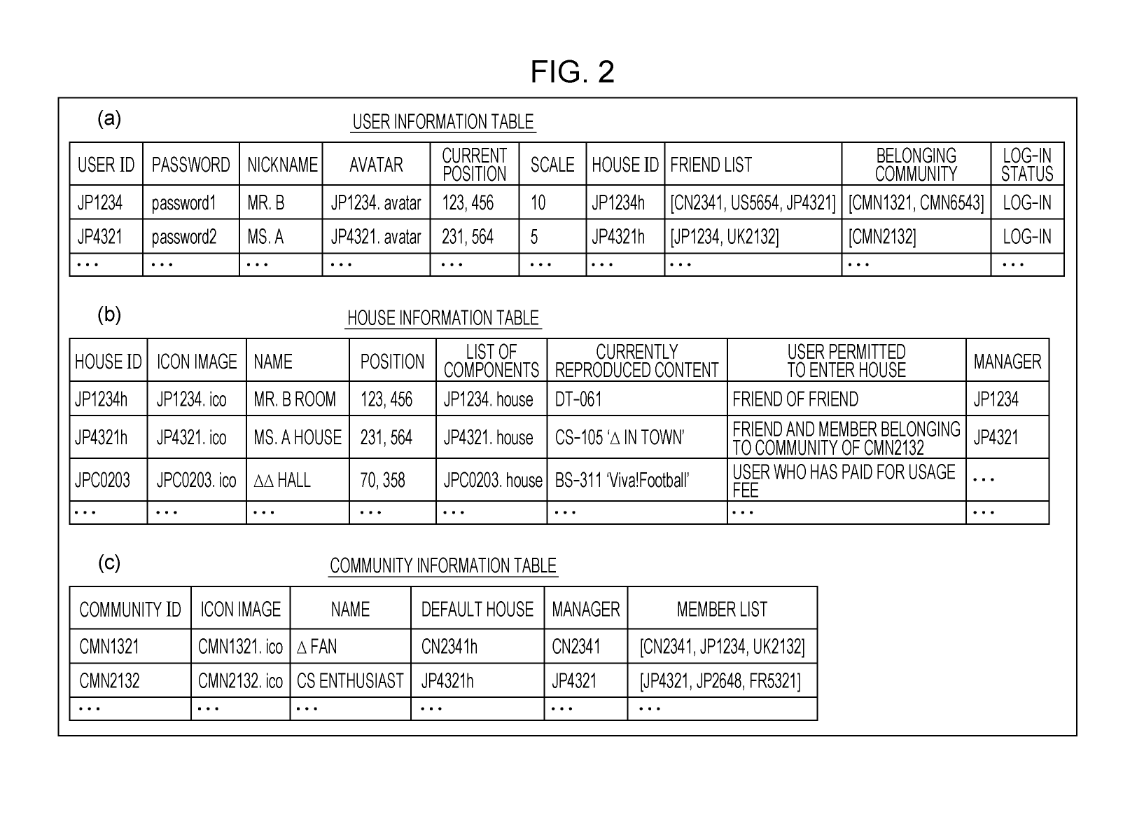

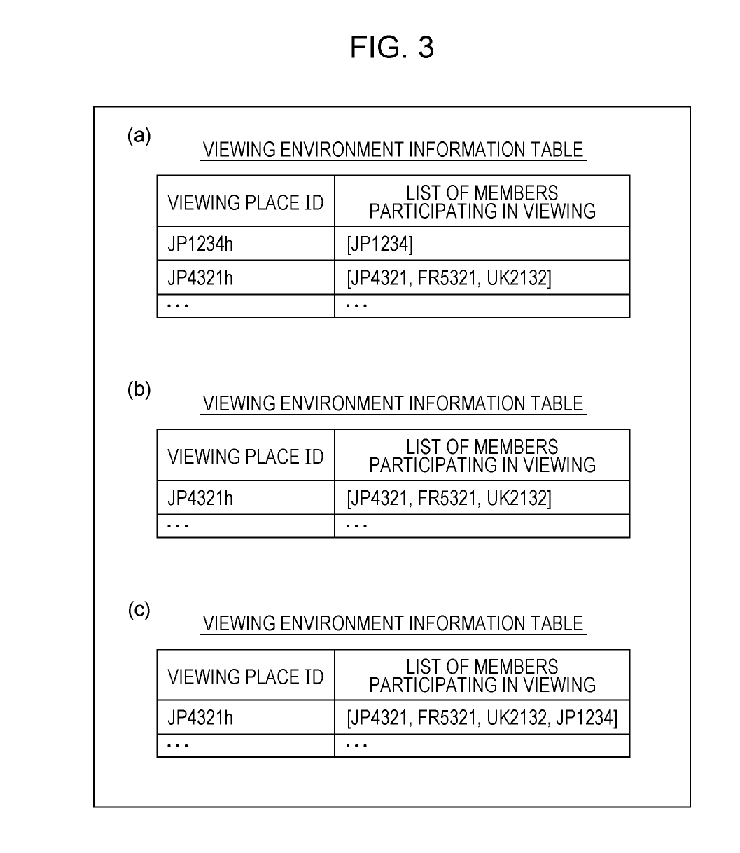

Next, various tables recorded in the storage unit 110 will be described more specifically with reference to FIGS. 1 to 3. FIG. 2 schematically illustrates various tables recorded in the storage unit 110. FIG. 3 schematically illustrates a viewing environment information table recorded in the storage unit 110.

As illustrated in FIG. 1, a database saved in the storage unit 110 includes the aforementioned user information table and viewing environment information table, a house information table, and a community information table.

### (User Information Table)

As illustrated in FIG. 2(a), the user information table is constituted by fields of a “user ID”, a “password”, a “nickname”, an “avatar”, a “current position”, a “scale”, a “house ID”, a “friend list”, a “belonging community”, and a “log-in status”.

A value of the “user ID” field is a value indicating a unique ID of each user of the group-viewing service. A value of the “password” field is a value that is set when a corresponding user is registered in the group-viewing service and is used for group authentication together with the value of the “user ID” field.

A value of the “nickname” field is a value that is set when the corresponding user is registered in the group-viewing service and indicates a nickname of the corresponding user. A value of the “avatar” field is a value indicating a file name of an avatar selected when the corresponding user is registered in the group-viewing service.

A value of the “current position” field is a value indicating a current position of a character, which represents the corresponding user, in the virtual world. A value of the “scale” field is a value indicating a scale of the virtual map, which is set by the corresponding user through a virtual map screen.

A value of the “house ID” field is an ID indicating a house of the character, which represents the corresponding user, in the virtual world. Note that, the house is automatically built in the virtual world when the corresponding user is registered in the group-viewing service.

A value of the “friend list” field is a list value formed by user IDs of users who are in a friendly relationship with the corresponding user.

A value of the “belonging community” field is a list value formed by community IDs of communities to which the corresponding user belongs.

A value of the “log-in status” field is a value indicating a log-in status of the corresponding user.

### (House Information Table)

The house information table is a table including information about each of buildings where group-viewing is able to be performed in the virtual world. As the buildings, there are the aforementioned house and a building structure (such as a hall) built in the virtual world by a user.

As illustrated in FIG. 2(b), the house information table is constituted by fields of a “house ID”, an “icon image”, a “name”, a “position”, a “list of components”, a “currently reproduced content”, a “user permitted to enter house”, and a “manager”.

A value of the “house ID” field is a value indicating a unique ID of each of the buildings described above.

A value of the “icon image” field is a value indicating a file name of an icon (building icon) which represents a corresponding building.

A value of the “name” field is a value indicating a name of the corresponding building and is displayed beside a corresponding building icon (such as a building icon representing a house) in the virtual map.

A value of the “position” field is a value indicating a position of the corresponding building in the virtual world.

A value of the “list of components” field is a value indicating a list of components (for example, such as an image file indicating a background image) that form a screen (for example, a My House screen described later) indicating the inside of the corresponding building.

A value of the “currently reproduced content” field is a value indicating a content under group-viewing in the corresponding building.

A value of the “user permitted to enter house” field is a value indicating a user who is able to participate in the group-viewing in the corresponding building.

A value of the “manager” field is a value indicating a user ID of a manager of the corresponding building.

### (Community Information Table)

The community information table is a table including information about various communities formed in the virtual world.

As illustrated in FIG. 2(c), the community information table is constituted by fields of a “community ID”, an “icon image”, a “name”, a “default house”, a “manager”, and a “member list”.

A value of the “community ID” field is a value indicating a unique ID of each of the communities described above.

A value of the “icon image” field is a value indicating a file name of an icon which represents a corresponding community.

A value of the “name” field is a value indicating a name of the corresponding community.

A value of the “default house” field is a value indicating at which building in the virtual world setting about the corresponding community is able to be changed.

A value of the “manager” field is a value indicating a manager of the corresponding community.

A value of the “member list” field is a list value formed by user IDs of members participating in the corresponding community.

### (Viewing Environment Information Table)

As illustrated in FIG. 3, the viewing environment information table is constituted by fields of a “viewing place ID” and a “list of members participating in viewing”.

A value of the “viewing place ID” field is a value indicating a place where a content is viewed by one person or a group in the virtual world.

A value of the “list of members participating in viewing” field is a list formed by user IDs of one or more users participating in viewing at a corresponding place in the virtual world.

Next, an operation of the system when the group-viewing application starts and when it is terminated will be described.

(Operation of System when Group-Viewing Application Starts)

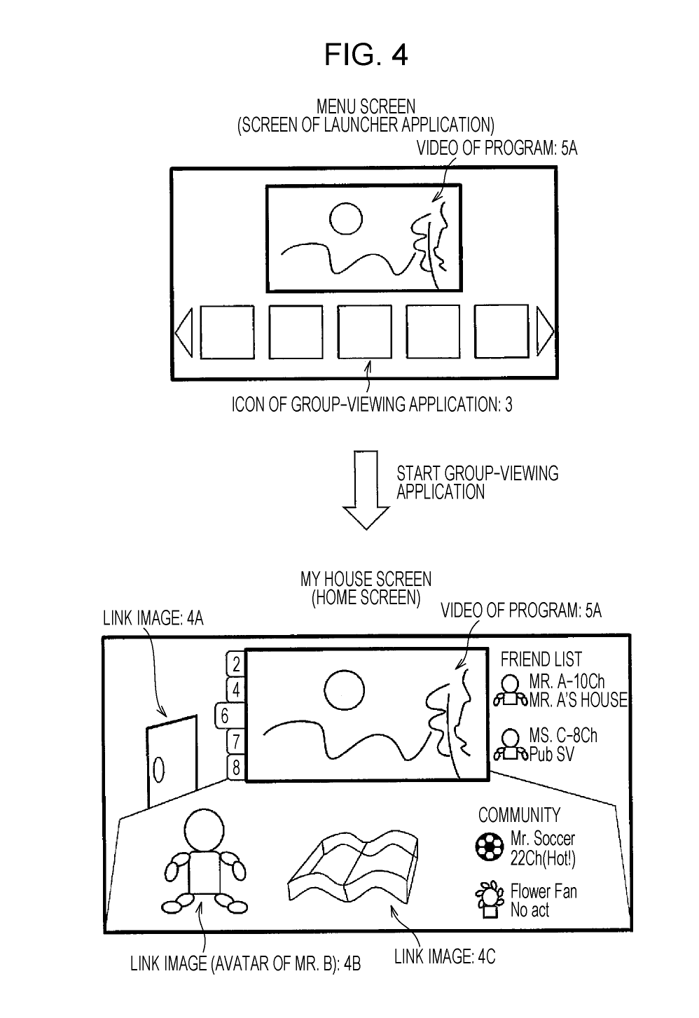

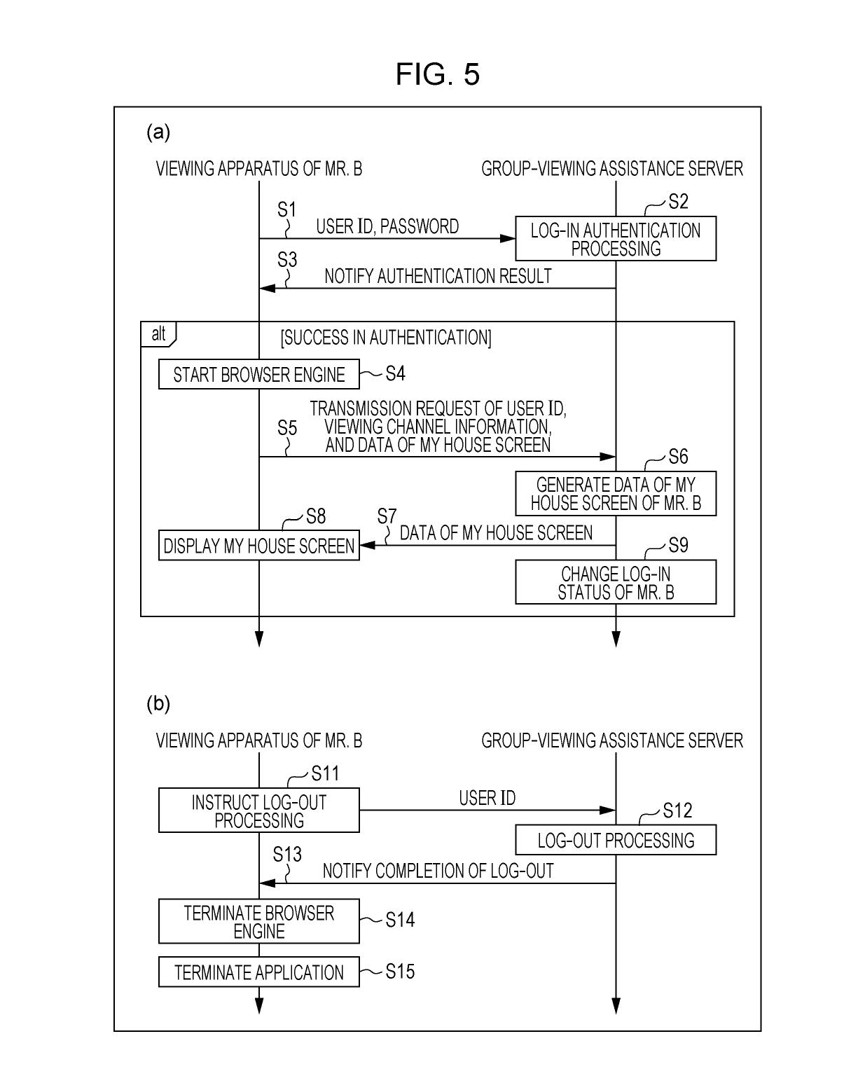

First, an operation of the system when the group-viewing application starts will be described with reference to FIG. 4 and FIG. 5(a).

FIG. 4 illustrates a launcher screen and a main screen (My House screen described later) of the group-viewing application that are displayed on the viewing apparatus 200. FIG. 5(a) illustrates the operation of the system when the group-viewing application starts.

When a user (here, a nickname of the user is set as “Mr. B”) of the viewing apparatus 200 clicks an icon 3 in a menu screen of FIG. 4, the viewing apparatus 200 of Mr. B starts the group-viewing application.

### (Step S1)

The application processing unit 221 of the viewing apparatus 200 of Mr. B displays an input screen for a user ID and a password when the group-viewing application starts. Then, the application processing unit 221 transmits data, which includes a user ID and a password that are input by using the operation reception unit 250, to the group-viewing assistance server 100.

### (Step S2)

After step S1, the reception data analysis unit 121 of the group-viewing assistance server 100 analyzes the data transmitted at step S1 and specifies that the data is data related to a log-in request. The reception data analysis unit 121 provides the user ID and the password to the authentication processing unit 125 and thereby instructs the authentication processing unit 125 to perform log-in authentication processing.

The authentication processing unit 125 having received the instruction determines whether or not a record including a pair formed by the user ID and the password which are provided is in the user information table.

### (Step S3)

After step S2, the authentication processing unit 125 notifies the viewing apparatus 200 of Mr. B of information indicating a result of the log-in authentication. That is, when determining that the corresponding record is in the user information table at step S2, the authentication processing unit 125 notifies the viewing apparatus 200 of Mr. B of information indicating that the log-in authentication is performed successfully. On the other hand, when determining that the corresponding record is not in the user information table at step S2, the authentication processing unit 125 notifies the viewing apparatus 200 of Mr. B of information indicating that the log-in authentication fails.

### (Step S4)

When the viewing apparatus 200 of Mr. B receives the information indicating that the log-in authentication is performed successfully, the application processing unit 221 starts a browser engine for performing processing according to an HTTP protocol.

### (Step S5)

After step S4, the application processing unit 221 transmits, to the group-viewing assistance server 100, an HTTP request to request transmission of the My House screen (home screen) of FIG. 4. The HTTP request includes a user ID of Mr. B and viewing channel information indicating a channel reproduced by the viewing apparatus 200 of Mr. B.

### (Step S6)

After step S5, the reception data analysis unit 121 analyzes the HTTP request transmitted at step S5, provides the screen data transmission processing unit 122 with the user ID of Mr. B and the viewing channel information, and instructs the screen data transmission processing unit 122 to perform generation and transmission of data of a My House screen for Mr. B.

The screen data transmission processing unit 122 having received the instruction performs following three processing (processing 1 to processing 3) for generating data of the My House screen for Mr. B.

(Processing 1) User information (values of the fields of the “house ID”, the “friend list”, and the “belonging community”) of Mr. B is read from the user information table.
(Processing 2) A record (house information about a house of a character of Mr. B in the virtual world) including the read value of the “house ID” field is read from the house information table.
(Processing 3) Model data of the My House screen is read from the storage unit 210, and the data of the My House screen for Mr. B is generated by using the model data, the user information and the house information which are read in the processing 1 and the processing 2, and the viewing channel information.

### (Step S7)

The screen data transmission processing unit 122 transmits, to the viewing apparatus 200 of Mr. B, an HTTP response including the data of the My House screen for Mr. B generated at step S6.

### (Step S8)

The application processing unit 221 records the data (HTML data) of the My House screen for Mr. B transmitted at step S7 in the storage unit 110 and performs display processing of the My House screen for Mr. B on the basis of the data. The display processing also includes processing for acquiring various images (various images designated by the HTML data) in the My House screen from the group-viewing assistance server 100 through HTTP communication. The display processing further includes processing for displaying the various images acquired through HTTP communication and a video of a broadcasting program in a region designated by the HTML data.

As a result, the My House screen (home screen) as illustrated in FIG. 4 is displayed on the display unit 260 of the viewing apparatus 200 of Mr. B.

### (Step S9)

After step S7, the DB update processing unit 123 updates a log-in status of Mr. B on the basis of an instruction from the screen data transmission processing unit 122. That is, the DB update processing unit 123 updates a value of the “log-in status” field of the record corresponding to Mr. B in the user information table from “log-out” to “log-in”.

As described above, the system performs the operation indicated in FIG. 5(a).

Note that, when the viewing apparatus 200 of Mr. B receives information indicating that the log-in authentication fails as a result of performing step S3, the viewing apparatus 200 of Mr. B displays a message indicating that log-in fails, stops the processing for starting the group-viewing application, and then displays the menu screen of FIG. 4 again.

(Operation of System when Group-Viewing Application is Terminated)

Next, an operation of the system when the group-viewing application is terminated will be described with reference to FIG. 4 and FIG. 5(b).

FIG. 5(b) illustrates the operation of the system when the group-viewing application is terminated.

### (Step S11)

When the operation reception unit 250 of the viewing apparatus 200 of Mr. B receives an operation to terminate the group-viewing application, the application processing unit 221 transmits, to the group-viewing assistance server 100, data to request log-out processing. The data includes the user ID of Mr. B.

### (Step S12)

After step S11, the reception data analysis unit 121 of the group-viewing assistance server 100 analyzes the data transmitted at step S11 and provides the DB update processing unit 133 with the user ID to thereby instruct the DB update processing unit 133 to perform log-out processing.

The DB update processing unit 133 having received the instruction updates a value of the “log-in status” field of a record which includes the provided user ID in the user information table from “log-in” to “log-out”.

### (Step S13)

After step S12, the authentication processing unit 125 notifies the viewing apparatus 200 of Mr. B of information indicating that the log-out processing is completed.

### (Step S14)

When the viewing apparatus 200 of Mr. B receives the notification of step S13, the application processing unit 221 terminates the browser engine.

### (Step S15)

After step S14, the application processing unit 221 performs processing for terminating the group-viewing application.

As described above, the system performs the operation indicated in FIG. 5(a).

### (About My House Screen)

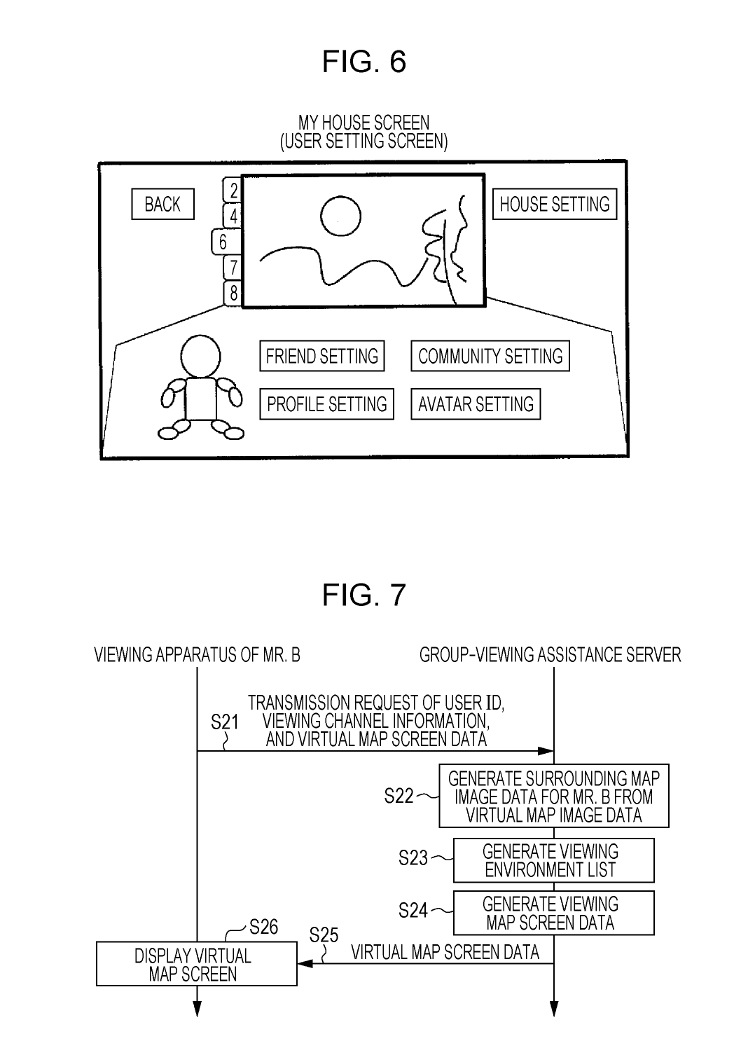

Details of the My House screen will be described with reference to FIGS. 4 and 6.

FIG. 6 illustrates the My House screen (user setting screen) displayed on the viewing apparatus 200.

As found from FIGS. 4 and 6, the My House screen is constituted by a plurality of types of screens (a home screen and a user setting screen).

As illustrated in FIG. 4, the My House screen (home screen) includes a region where a video of a content (a video of a program 5A) is displayed. The My House screen (home screen) also includes three link images (link images 4A, 4B, and 4C).

The link image 4A is an image including link to a virtual map screen described later.

The link image 4B is an avatar image (that is, an avatar image corresponding to a file name JP1234.avatar) of the user (Mr. B) of the viewing apparatus 200. The link image 4B includes link to the My House screen (user setting screen) of FIG. 6.

The link image 4C is an image including link to a search screen. The search screen is a screen in which information of a specific user (and/or a specific community) among all users (and/or all communities) registered in the group-viewing service is searched for. Note that, various known screens are able to be adopted as the search screen.

As illustrated in FIG. 6, the My House screen (user setting screen) also includes a region where a video of a content (a video of a program 5A) is displayed. The My House screen (user setting screen) includes a “house setting” button, a “friend setting” button, a “community setting” button, a “profile setting” button, an “avatar setting” button, and a “back” button.

The “house setting” button is a button for changing look-and-feel (user interface) of the My House screen of the user. The “friend setting” button is a button for the user to build and/or cancel friendships with another user. The “community setting” button is a button for the user to newly establish a community or to dissolve the community established by the user. Note that, a community setting screen that is displayed when the “community setting” button is pressed is desired to be a screen in which not only establishment and dissolving of a community but also participation in an existing community and/or withdrawing from an existing community are able to be performed.

The “profile setting” button is a button for changing a profile (a password, a nickname, public information, or the like) of the user. The “avatar setting” button is a button for changing an image (avatar image) of a character corresponding to the user.

Note that, as illustrated in FIGS. 4 and 6, a plurality of tabs (channel selection tabs) in each of which a channel number is indicated are arranged beside the region where the video of the content is displayed in both of the My House screens. When any channel selection tab among the channel selection tabs is clicked, the application processing unit 221 instructs the channel selection processing unit 222 to select a channel corresponding to the clicked channel selection tab.

(Operation while Group-Viewing Application is Executed)

Next, an operation of the system while the group-viewing application is executed will be described with reference to FIGS. 7 to 13.

(Operation of System when Operation of Displaying Virtual Map Screen is Performed)

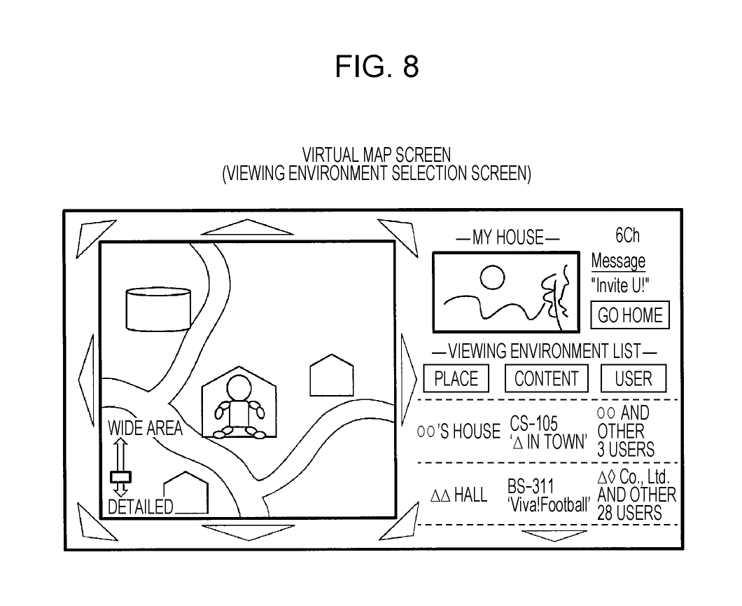

First, an operation of the system when an operation of displaying a virtual map screen on the viewing apparatus 200 is performed will be described with reference to FIGS. 7 and 8.

FIG. 7 is a sequence view illustrating an operation of the system when the viewing apparatus 200 receives such an operation. FIG. 8 illustrates the virtual map screen displayed on the viewing apparatus 200.

### (Step S21)

When the viewing apparatus 200 of Mr. B receives the aforementioned operation, the application processing unit 221 transmits, to the group-viewing assistance server 100, an HTTP request to request transmission of the virtual map screen illustrated in FIG. 8. The HTTP request includes the user ID of Mr. B and viewing channel information indicating a channel reproduced by the viewing apparatus 200 of Mr. B.

### (Step S22)

After step S21, the reception data analysis unit 121 analyzes the HTTP request transmitted at step S21, provides the DB update processing unit 123 with the user ID of Mr. B, and instructs the DB update processing unit 123 to delete a record including a viewing place ID, which has a similar value to that of a house ID of the house of Mr. B, from the viewing environment information table.

The DB update processing unit 123 having received the instruction updates the viewing environment information table in accordance with the instruction, and notifies that the update is completed to the reception data analysis unit 121. For example, the DB update processing unit 123 updates the viewing environment information table of FIG. 3(a) to the viewing environment information table of FIG. 3(b).

The reception data analysis unit 121 having received the notification provides the screen data transmission processing unit 122 with the user ID of Mr. B and the viewing channel information, and instructs the screen data transmission processing unit 122 to perform generation and transmission of data of a virtual map screen for Mr. B.

The screen data transmission processing unit 122 having received the instruction generates surrounding map image data for Mr. B from virtual map image data.

Specifically, the screen data transmission processing unit 122 performs following three processing (processing 4 and processing 5).

(Processing 4) User information (values of the fields of the “current position”, the “scale”, and the “avatar”) of Mr. B is read from the user information table and data of an avatar image of Mr. B is further read.
(Processing 5) The virtual map image data is read and an image (surrounding map image) of a partial range (a range having an area according to the scale) with a current position of the character of Mr. B as a center is extracted from the virtual map image to thereby generate surrounding map image data.
(Processing 6) Records (records corresponding to user information of users other than Mr. B) of the user information table, in each of which a value of the “current position” field is a value indicating to be within the partial range, are specified. Then, user information (values of the fields of the “current position” and the “avatar”) of each of the specified records is read, and avatar image data of other users is read.

### (Step S23)

After step S22, the screen data transmission processing unit 122 generates a viewing environment list.

Specifically, the screen data transmission processing unit 122 performs following three processing (processing 7 to processing 9) to thereby generate the viewing environment list.

(Processing 7) Records of the house information table, in each of which a value of the “position” field is a value indicating to be within the partial range, are specified, and house information (values of the fields of the “house ID”, the “name”, the “icon image”, the “position”, the “manager”, and the “currently reproduced content”) of each of the specified records is read. An icon image of each of the specified records is further read.
(Processing 8) By referring to the user information table, a nickname of a manager of each of the records specified in the processing 7 is specified.
(Processing 9) Records of the viewing environment information table, in each of which a value of the “viewing place ID” field matches the value of the “house ID” field of the record specified in the processing 7, are specified. Further, a value of the “list of members participating in viewing” field of each of the specified records is read.

For example, it is assumed that a value of “◯◯'s house” is read in the processing 7 as the value of the “name” field of a certain record (a record in which a value of the “position” field is closest to a value indicating the current position of the character of Mr. B) of the house information table. In addition, it is assumed that a value of “CS-105 ‘Δ in town’” is read as the value of the “currently reproduced content” field of the record, and a value of “◯◯” is read as the value of the “nickname” field in the processing 8. Further, it is assumed that a list value formed by four user IDs including a user ID of “◯◯” is read as the value of the “list of members participating in viewing” field in the processing 9.

In such a case, the screen data transmission processing unit 122 generates a viewing environment list in which elements corresponding to ◯◯'s group (four characters, including a character of ◯◯, who gather in ◯◯'s house closest to the current position of the character of Mr. B in the virtual world) serve as elements on the top, as illustrated in FIG. 8. That is, the present embodiment has a characteristic that a group corresponding to elements closer to the top in the viewing environment list serves as a group linked to a point at a closer distance from the character of Mr. B. However, the characteristic is peculiar to the present embodiment and the group-viewing assistance device according to the invention may not have such a characteristic.

Note that, as found from the description above, the viewing environment list indicates, for each of groups linked to a point (for example, house) in the aforementioned partial range, a point (for example, “◯◯'s house” described above) in which the group is gathered, a user (for example, “◯◯” who manages “◯◯ house”) who manages the point, the number of members of the group, and a content under group-viewing.

### (Step S24)

After step S23, the screen data transmission processing unit 122 reads model data of the virtual map screen from the storage unit 210, and uses the model data, the viewing environment list generated at step S23, the viewing channel information, and the information read from each of the tables in the processing 4 to processing 9 to generate data (HTML data) of the virtual map screen for Mr. B.

Note that, values of coordinates, at which building icons are displayed, needed for generating the HTML data are able to be calculated by using the value of the “current position” field read in the processing 4 and the value of the “position” field of each of the records read in the processing 5. Values of coordinates, at which avatar images are displayed, needed for generating the HTML data are able to be calculated by using the value of the “current position” field read in the processing 4 and the value of the “current position” field of each of the records read in the processing 6.

### (Step S25)

The screen data transmission processing unit 122 transmits, to the viewing apparatus 200 of Mr. B, an HTTP response including the data of the virtual map screen for Mr. B, which is generated at step S24.

### (Step S26)

The application processing unit 221 records the data (HTML data) of the virtual map screen for Mr. B transmitted at step S25 in the storage unit 110 and performs display processing of the virtual map screen for Mr. B on the basis of the data. The display processing also includes processing for acquiring various images (for example, surrounding map image data, building icons, avatar image data of Mr. B, and the like which are designated by the HTML data) in the virtual map screen from the group-viewing assistance server 100 through HTTP communication. The display processing further includes processing for displaying the various images acquired through HTTP communication and a video of a broadcasting program in a region designated by the HTML data.

As a result, the virtual map screen (viewing environment selection screen) as illustrated in FIG. 8 is displayed on the display unit 260 of the viewing apparatus 200 of Mr. B.

Note that, Mr. B is able to perform an operation of moving his character in the virtual world while the virtual map screen is displayed. Specifically, the operation is an operation of clicking any direction button of eight direction buttons (triangular-arrow direction buttons) arranged around the display region of the surrounding map image in the virtual map screen. When any direction button (triangular arrow) of the eight direction buttons is clicked, the character of Mr. B moves in the direction in which the clicked triangular arrow is directed.

Mr. B is also able to perform an operation of changing a scale of the surrounding map image while the virtual map screen is displayed. Specifically, the operation is an operation of moving a position of a knob of a scale bar on the surrounding map image to a position corresponding to a desired scale. Note that, a “+” button and a “−” button may be provided on the surrounding map image. In this case, an operation of clicking the “+” button may be an operation of zooming in the surrounding map image and an operation of clicking the “−” button may be an operation of zooming out the surrounding map image.

(Operation of System when Operation for Virtual Map is Performed)

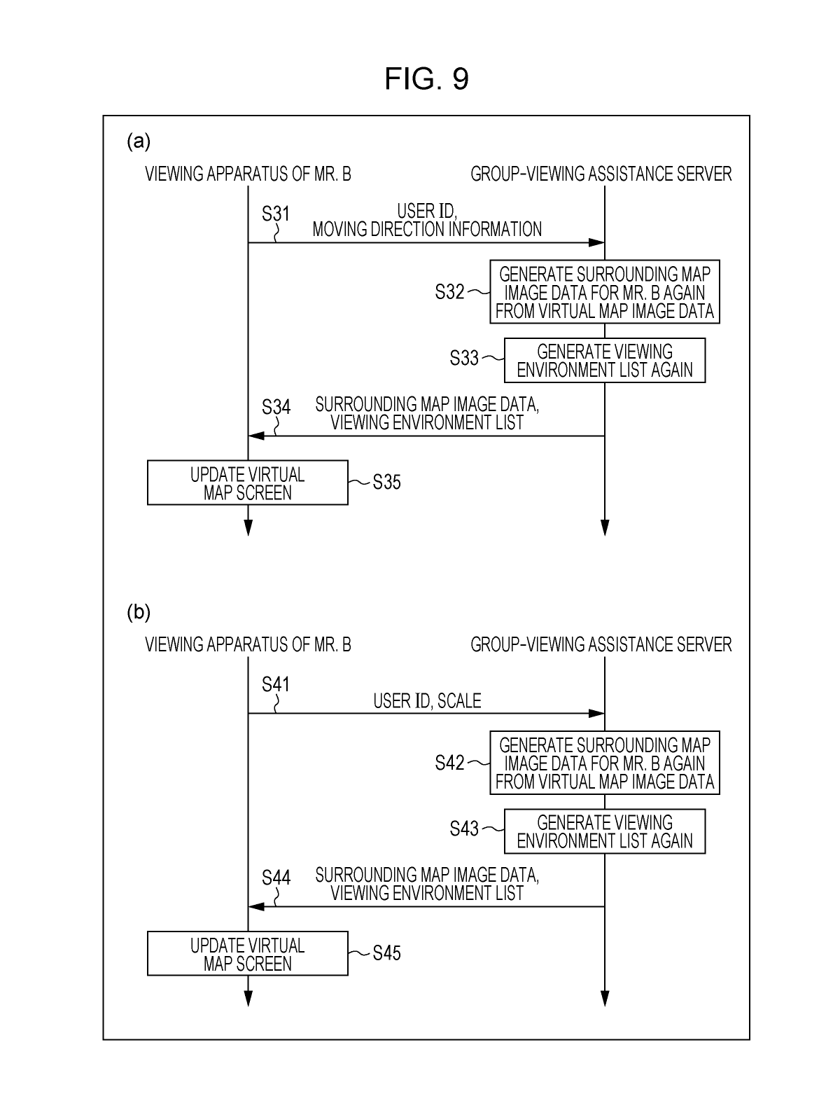

Next, an operation of the system when an operation for the virtual map is performed will be described with reference to FIGS. 9 to 11.

FIG. 9 is a sequence view illustrating an operation of the system when an operation for the virtual map is received by the viewing apparatus 200. Specifically, FIG. 9(a) illustrates an operation of the system when an operation of moving one's character (my avatar) is performed and FIG. 9(b) illustrates an operation of the system when an operation of changing the scale of the virtual map is performed.

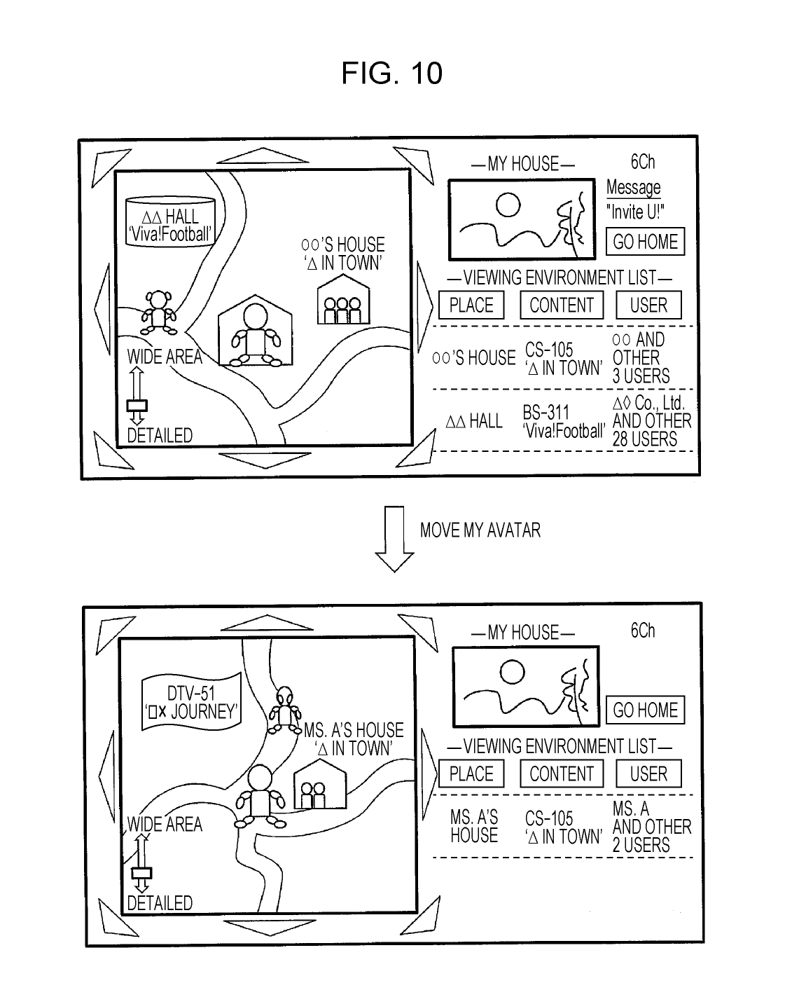

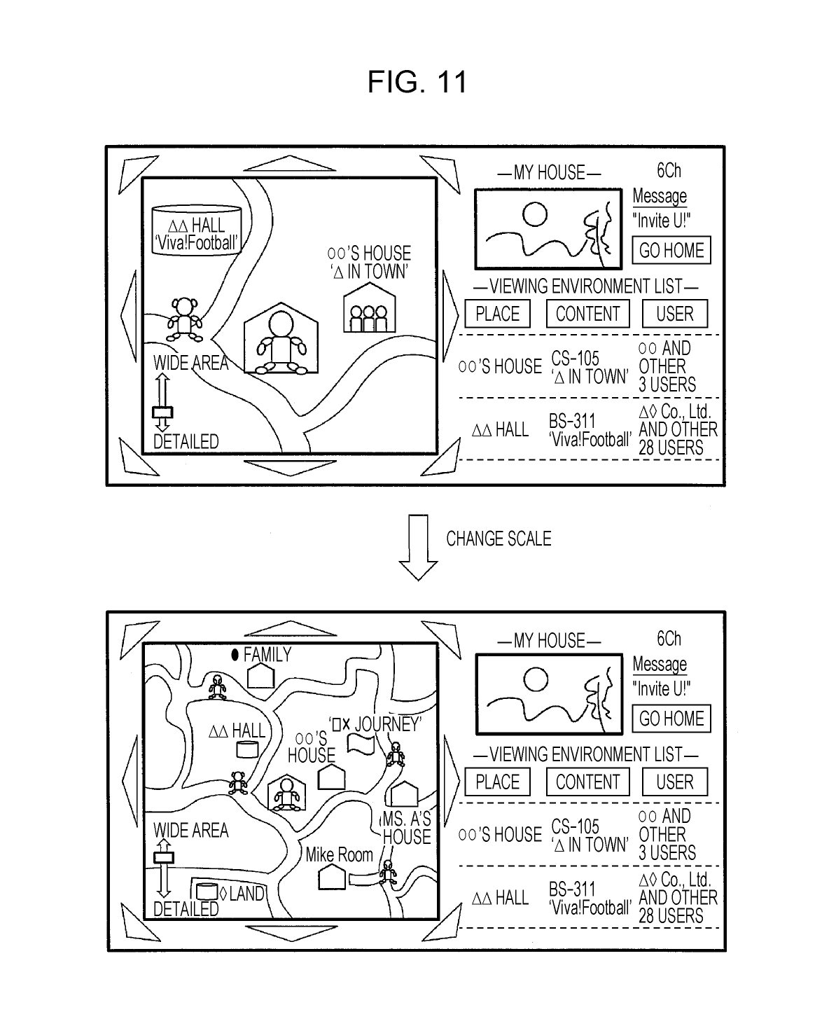

FIG. 10 is a view for explaining a change in the virtual map screen associated with the operation of moving one's character, and FIG. 11 is a view for explaining a change in the virtual map screen associated with the operation of changing the scale of the virtual map.

First, the operation of the system when the operation of moving one's character (my avatar) is performed will be described with reference to FIG. 9 and FIG. 10(a).

### (Step S31)

When the viewing apparatus 200 of Mr. B receives the operation of moving the character of Mr. B, the application processing unit 221 transmits, to the group-viewing assistance server 100, an HTTP request to request transmission of information for updating the virtual map screen. The HTTP request includes the user ID of Mr. B and moving direction information that indicates in which direction of the eight predetermined directions the character has moved.

### (Step S32)

After step S31, the reception data analysis unit 121 analyzes the HTTP request transmitted at step S31, and provides the DB update processing unit 123 with the user ID of Mr. B and the moving direction information. The DB update processing unit 123 specifies a record including user information of MR. B from the user information table in accordance with the user ID of Mr. B and updates a value of the “current position” field of the record on the basis of the moving direction information.

The reception data analysis unit 121 having received notification of completion of the update from the DB update processing unit 123 provides the screen update information transmission processing unit 124 with the user ID of Mr. B and instructs the screen update information transmission processing unit 124 to perform generation and transmission of information for updating the virtual map screen for Mr. B.

The screen update information transmission processing unit 124 having received the instruction executes the processing 4 to processing 6 described above to thereby generate surrounding map image data.

### (Step S33)

After step S32, the screen update information transmission processing unit 124 generates a viewing environment list by performing the processing 7 to processing 9 described above and generates display region information indicating regions where building icons and avatar images of other users are to be displayed in the surrounding map image.

### (Step S34)

After step S33, the screen update information transmission processing unit 124 transmits, to the viewing apparatus 200 of Mr. B, the surrounding map image data, the viewing environment list, the display region information, the building icons, and the avatar images of other users as the information for updating the virtual map screen for Mr. B.

### (Step S35)

After step S34, the application processing unit 221 updates the virtual map screen by using the surrounding map image data, the viewing environment list, the display region information, the building icons, and the avatar images of other users.

Specifically, the application unit 221 performs following processing.

That is, the application processing unit 221 deletes the surrounding map image that has been displayed so far and newly displays the surrounding map image indicated by the surrounding map image data transmitted at step S34. In addition, the application processing unit 221 deletes the avatar images of other users that have been displayed so far and newly displays the avatar images transmitted at step S34 in the region indicated by the display region information transmitted at step S34.

Similarly, the application processing unit 221 deletes the building icons that have been displayed so far and newly displays the building icons transmitted at step S34 in the region indicated by the display region information transmitted at step S34. Further, the application processing unit 221 deletes the viewing environment list that has been displayed so far and newly displays the viewing environment list transmitted at step S34.

As a result, the virtual map screen is updated, for example, as illustrated in FIG. 10.

Next, an operation of the system when the operation of changing the scale of the virtual map is performed will be described with reference to FIG. 10(b) and FIG. 11.

### (Step S41)

When the viewing apparatus 200 of Mr. B receives the operation of changing the scale, the application processing unit 221 updates a display state of the scale bar and transmits, to the group-viewing assistance server 100, an HTTP request to request transmission of information for updating the virtual map screen. The HTTP request includes the user ID of Mr. B and the changed scale.

### (Step S42)

After step S41, the reception data analysis unit 121 analyzes the HTTP request transmitted at step S41 and provides the DB update processing unit 123 with the user ID of Mr. B and the scale. The DB update processing unit 123 specifies a record including user information of Mr. B from the user information table on the basis of the user ID of Mr. B and updates a value of the “scale” field of the record to have the same value as the scale provided from the reception data analysis unit 121.

The reception data analysis unit 121 having received notification of completion of the update from the DB update processing unit 123 provides the screen update information transmission processing unit 124 with the user ID of Mr. B and instructs the screen update information transmission processing unit 124 to perform generation and transmission of the information for updating the virtual map screen for Mr. B.

The screen update information transmission processing unit 124 having received the instruction executes the processing 4 to processing 6 described above to thereby generate surrounding map image data.

(Step S43 to step S45)

After step S42, the system executes each processing of step S43 to step S45. Note that, at step S43 to step S45, the system respectively performs the same processing as that of step S33 to step S35 which have been already described.

As a result, the virtual map screen is updated, for example, as illustrated in FIG. 11.

(Operation of System when Operation to Participate in Group-Viewing Performed in Different House on Virtual Map is Performed)

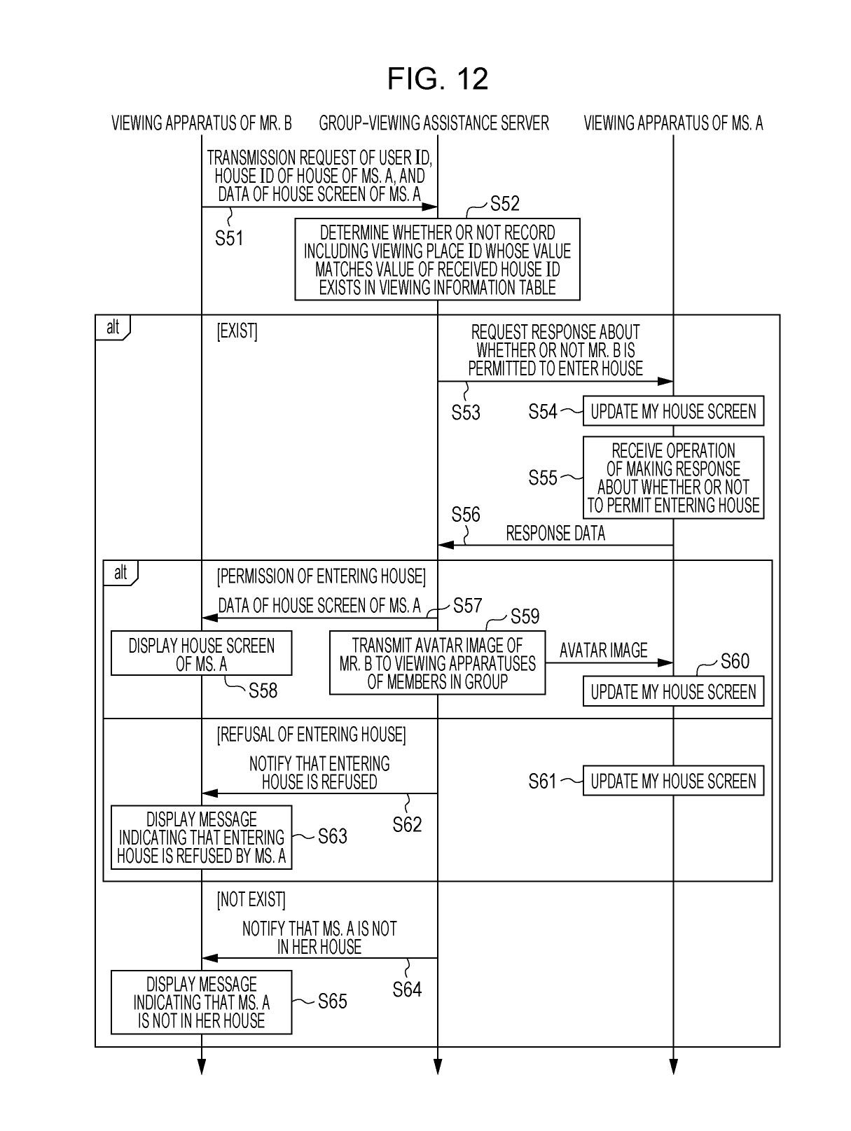

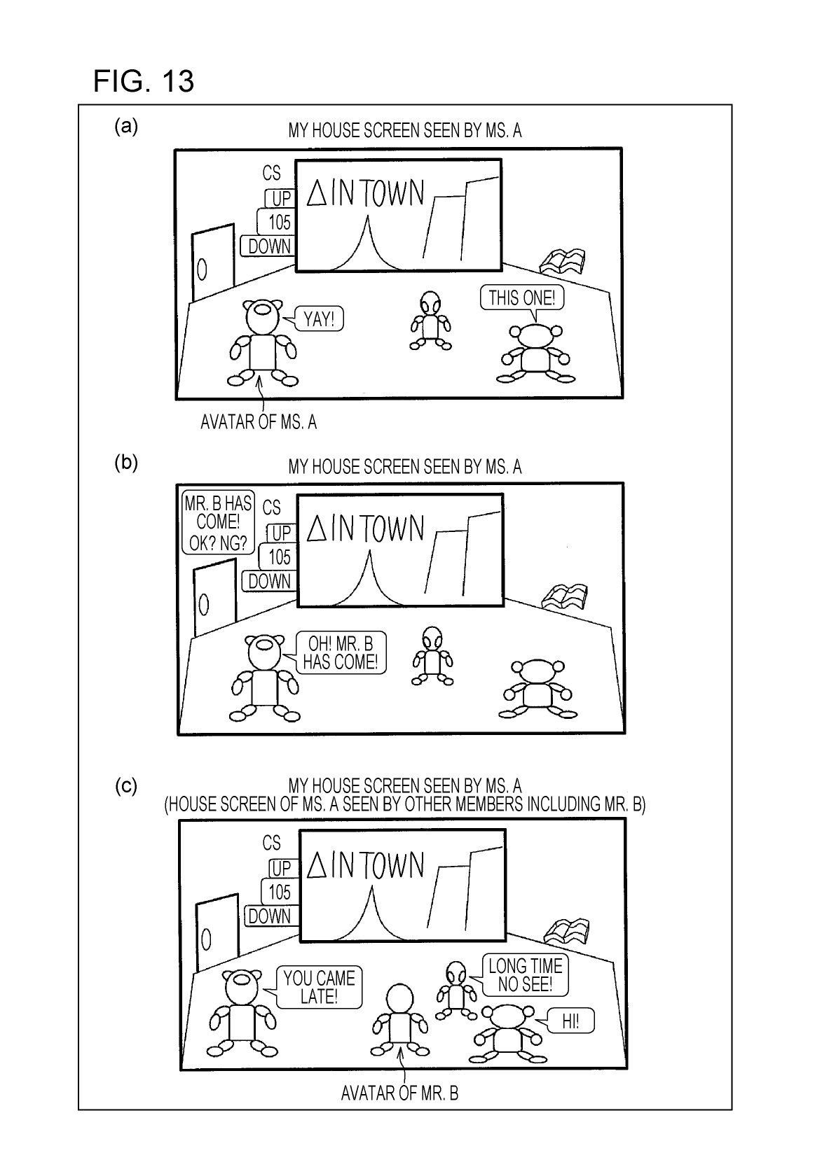

Various operations of the system have been described above, and an operation of the system when an operation to participate in group-viewing performed in a different house on the virtual map is performed will be lastly described with reference to FIGS. 12 and 13.

FIG. 12 is a sequence view illustrating an operation of the system when the viewing apparatus 200 receives such an operation. FIG. 13 illustrates a screen displayed on a viewing apparatus 200 of Ms. A who is a manager of the different house.

Note that, an operation of designating a group to be participated in as to group-viewing performed by gathering in a different house on the virtual map is an operation of designating an object corresponding to the different house in which the group (characters of users belonging to the group) is gathered. In the present embodiment, an operation of moving one's character (my avatar) to an icon of the different house corresponds to an operation of designating an object. Note that, another type of operation may be performed as the operation of designating an object in another embodiment.

### (Step S51)

When the viewing apparatus 200 of Mr. B receives the operation to participate in group-viewing performed in a house of Ms. A (a character of Ms. A) in the virtual world, the application processing unit 221 transmits, to the group-viewing assistance server 100, an HTTP request to request transmission of data of a house screen of a different user. The HTTP request includes the user ID of Mr. B and a house ID of the house of Ms. A.

### (Step S52)

After step S51, the reception data analysis unit 121 analyzes the HTTP request transmitted at step S51 and provides the screen update information transmission processing unit 124 with the user ID of Mr. B and the house ID of the house of Ms. A.

The screen update information transmission processing unit 124 specifies a record, which corresponds to the house ID provided from the reception data analysis unit 121, from the house information table. The screen update information transmission processing unit 124 determines whether or not Mr. B (the character of Mr. B) is able to enter the house of Ms. A by referring to a value of the “user permitted to enter house” field of the specified record.

When determining that Mr. B is able to enter the house of Ms. A, the screen update information transmission processing unit 124 further determines whether a record including a viewing place ID whose value matches the value of the house ID provided from the reception data analysis unit 121 exists in the viewing environment information table.

### (Step S53)

When determining that the corresponding record exists in the viewing environment information table at step S52, the screen update information transmission processing unit 124 transmits, to the viewing apparatus 200 of Ms. A, a request of a response about whether or not Mr. B is permitted to enter the house.

### (Step S54)

After step S53, the application processing unit 221 of the viewing apparatus 200 of Ms. A updates a My House screen seen by Ms. A so that a dialog for making a response about whether or not Mr. B is permitted to enter her house appears. In a case where the application processing unit 221 updates, for example, the My House screen of FIG. 13(a) after step S53 and further Ms. A tells about a visit of Mr. B by chatting, the My House screen seen by Ms. A is brought into a state as illustrated in FIG. 13(b), for example.

(Step S55, step S56)

When the operation reception unit 250 of the viewing apparatus 200 of Ms. A receives an operation of making a response about whether or not Mr. B is permitted to enter her house, the application processing unit 221 transmits, to the group-viewing assistance server 100, response data indicating the response about whether or not Mr. B is permitted to enter her house.

### (Step S57)

In a case where the response data transmitted from the viewing apparatus 200 of Ms. A at step S56 is data indicating that “Mr. B is permitted to enter the house of Ms. A”, the reception data analysis unit 121 instructs the DB update processing unit 123 to update a record including the viewing place ID whose value is similar to the value of the house ID of the house of Ms. A (specifically, to update a value of the “list of members participating in viewing” field of the record to a list value including the user ID of Mr. B).

The DB update processing unit 123 having received the instruction updates the viewing environment information table in accordance with the instruction and notifies that the update is completed to the reception data analysis unit 121. For example, the DB update processing unit 123 updates the viewing environment information table of FIG. 3(b) to the viewing environment information table of FIG. 3(c).

The reception data analysis unit 121 having received the notification instructs the screen data transmission processing unit 122 to perform generation and transmission of data of the house screen of Ms. A.

The screen data transmission processing unit 122 having received the instruction generates the data (HTML data) of the house screen of Ms. A and provides the viewing apparatus 200 of Mr. B with the generated data. A script for causing the viewing apparatus 200 of Mr. B to perform execution is embedded in the HTML data and the script includes a command for causing the viewing apparatus 200 of Mr. B to select a content (program) reproduced by the viewing apparatus 200 of Ms. A.

### (Step S58)

The application processing unit 221 (reproduction means) records the data (HTML data) of the house screen of Ms. A, which is transmitted at step S57, in the storage unit 110 and performs display processing of the house screen of Ms. A on the basis of the data.

The display processing also includes processing for acquiring various images (for example, data of avatar images of members designated by the HTML data, and the like) in the house screen of Ms. A from the group-viewing assistance server 100 through HTTP communication. The display processing also includes processing for displaying the various images acquired through HTTP communication in a region designated by the HTML data. The display processing further includes processing for instructing the channel selection processing unit 222 to select the content reproduced by the viewing apparatus 200 of Ms. A in accordance with the command included in the script and processing for displaying the content which is started to be reproduced by the reproduction unit 223 in a region designated by the HTML data.

Further, the application processing unit 221 (execution means) starts a standby of input of a character string using a keyboard (or a remote controller, a controller, or the like). When receiving input of a character string, the application processing unit 221 displays the input character string on the display unit 260 (the house screen of Ms. A) as a speech content of Mr. B and transmits the input character string to the group-viewing assistance server 100 (the character string transmitted to the group-viewing assistance server 100 is transmitted to viewing apparatuses 200 of Ms. A and other members and is displayed as the speech content of Mr. B in the house screen seen by Ms. A and other members).

### (Step S59)

After step S57, the reception data analysis unit 121 instructs the screen update information transmission processing unit 124 to transmit the avatar image of Mr. B to viewing apparatuses 200 of members whose corresponding characters gather in the house of Ms. A (the same point, a specific point).

The screen update information transmission processing unit 124 having received the instruction specifies a record including the user information of Mr. B from the user information table, refers to a value of the “avatar” field in the record, and transmits data of the avatar image of Mr. B to the viewing apparatuses 200 of the members.

### (Step S60)

After step S59, the application processing unit 221 of the viewing apparatus 200 of Ms. A updates the My House screen seen by Ms. A by displaying the avatar image of Mr. B after deleting the dialog to make a response about whether or not Mr. B is permitted to enter her house. Each of the application processing units 221 of the viewing apparatuses 200 of other members also updates the house screen of Ms. A seen by the members by displaying the avatar image of Mr. B.

In a case where the application processing unit 221 of the viewing apparatus 200 of Ms. A updates, for example, the My House screen of FIG. 13(b) after step S59 and further each member other than Mr. B tells about the visit of Mr. B by chatting, the My House screen seen by Ms. A is brought into a state as illustrated in FIG. 13(c), for example. In this case, the house screen of Ms. A seen by other members including Mr. B is also brought into the state as illustrated in FIG. 13(c).

As a result, Mr. B is able to perform remote communication (text chatting) while viewing the same program with other members (members who are not in the same place as that of Mr. B in an actual world) whose corresponding characters gather in the house of Ms. A.

### (Step S61)

When having transmitted response data indicating that “Mr. B is not permitted to enter the house of Ms. A” at step S56, the application processing unit 221 of the viewing apparatus 200 of Ms. A updates the My House screen seen by Ms. A so that the dialog for making a response about whether or not Mr. B is permitted to enter her house is deleted.

### (Step S62)

When the response data transmitted from the viewing apparatus 200 of Ms. A at step S56 is data indicating that “Mr. B is not permitted to enter the house of Ms. A”, the reception data analysis unit 121 instructs the screen update information transmission processing unit 124 to transmit information, which indicates that the entering house is refused by Ms. A, to the viewing apparatus 200 of Mr. B.

The screen update information transmission processing unit 124 transmits the information, which indicates that the entering house is refused by Ms. A, to the viewing apparatus 200 of Mr. B in accordance with the instruction.

### (Step S63)

After step S62, the application processing unit 221 of the viewing apparatus 200 of Mr. B updates the virtual map screen so that a message indicating that the entering house is refused by Ms. A is displayed.

### (Step S64)

When determining that the corresponding record is not in the viewing environment information table at step S52, the screen update information transmission processing unit 124 transmits information, which indicates that Ms. A (the character of Ms. A) is not in her house in the virtual world, to the viewing apparatus 200 of Mr. B.

### (Step S65)

After step S64, the application processing unit 221 of the viewing apparatus 200 of Mr. B updates the virtual map screen so that a message indicating that Ms. A is not in her house is displayed.

As above, various operations of the system have been described.

Note that, at step S64, the screen update information transmission processing unit 124 may specify a direction, in which Ms. A is, when seen from the house of Ms. A in the virtual world by specifying a place where Ms. A is in the virtual world. Then, the screen update information transmission processing unit 124 may transmit, to the viewing apparatus 200 of Mr. B, information indicating that Ms. A is not in her house in the virtual world and information indicating the direction, in which Ms. A is, when seen from the house of Ms. A in the virtual world.

In this case, the application processing unit 221 may display the message indicating that Ms. A is not in her house in the virtual world and the information indicating the direction in which Ms. A is in the virtual world at step S65. Note that, the information may be an image of a mark indicating the direction in which Ms. A is, and the image may be in a red color or may be an animation image which is recognized by Mr. B as being blinked.

### (Additional Matter 1)

When receiving an operation of clicking a name of a content in the viewing environment list, the viewing apparatus 200 of Mr. B may highlight a building icon corresponding to a place included in an element (line) that includes the name of the content.

Alternatively, when receiving such an operation, the viewing apparatus 200 of Mr. B may acquire detailed information of the content from the group-viewing assistance server 100 and display the acquired detailed information.

Alternatively, the viewing apparatus 200 of Mr. B, for each of eight direction buttons (triangular arrows), may inquire the group-viewing assistance server 100 of the number of groups gathering in a building positioned in a direction in which the triangular arrow is directed when seen from a position where the character of Mr. B is.

In this case, the group-viewing assistance server 100 having received the inquiry may specify in which direction each of all viewing places where group-viewing is performed is when seen from a place where the character of Mr. B is by referring to all records in the viewing environment information table. Then, the group-viewing assistance server 100, for each of eight directions, may count the number of groups performing group-viewing in a viewing place positioned in the direction when seen from the place where the character of Mr. B is, and notify the viewing apparatus 200 of Mr. B of a result thereof.

The viewing apparatus 200 of Mr. B having received the notification, for each of eight direction buttons (triangular arrows), may then display, on the direction button, the number of groups gathering in a building positioned in a direction in which the triangular arrow is directed when seen from the position where the character of Mr. B is.

### (Additional Matter 2)

When receiving an operation of moving the character of Mr. B to a character of a different user, the viewing apparatus 200 of Mr. B may request the group-viewing assistance server 100 to perform processing for requesting the different user to build friendships with Mr. B.

Alternatively, when receiving such an operation, the viewing apparatus 200 of Mr. B may acquire public information of the different user from the group-viewing assistance server 100 and display the acquired public information.

Alternatively, when receiving such an operation, the viewing apparatus 200 of Mr. B may request the group-viewing assistance server 100 to transmit information (for example, coordinate values indicating a position of a building icon representing a house of the different user in a coordinate system of the virtual world, and information indicating a direction in which the building icon representing the house of the different user is positioned when seen from the position where the character of Mr. B is) indicating the position of the house of the different user in the virtual world.

In this case, the screen update information transmission processing unit 124 may transmit, to the viewing apparatus 200 of Mr. B, information indicating the position of the house of the different user in the virtual world in accordance with the request.

### (Additional Matter 3)

As described above, though the operation to participate in group-viewing performed in a different house on the virtual map in the present embodiment is the operation of designating an object corresponding to the different house, the operation of designating the object may be an operation of clicking the object (specifically, a character string 7 as illustrated in FIG. 17, which indicates a place of the different house in the viewing environment list).

Alternatively, the operation of designating the object may be an operation of clicking an element (a line including the character string 7) including the character string 7 in the viewing environment list.

In such cases, the viewing apparatus 200 of Mr. B having received the operation of moving the character of Mr. B to the different house may acquire detailed information of the different house from the group-viewing assistance server 100 and display the acquired detailed information.

### (Additional Matter 4)

Though the number of servers used for providing the group-viewing service is one in the present embodiment, the invention is not limited to such a configuration. That is, a plurality of servers may be used to provide the group-viewing service.

In this case, it is only required that any server of the plurality of servers includes each of the plurality of functions provided by the group-viewing assistance server 100 according to the present embodiment.

### (Additional Matter 5)

The database may include an avatar information table constituted by a field of a file name of an avatar image and a field indicating a main color in the avatar image. In this case, an avatar setting screen displayed upon pressing of an “avatar setting” button may be configured so that by inputting a character string which indicates a color and pressing a search button, a target avatar image group that has the color as a main color is able to be searched for from all avatar images.

That is, when the search button is pressed in the viewing apparatus 200, the group-viewing assistance server 100 may specify the target avatar image group by referring to the avatar information table and transmit the specified avatar image group to the viewing apparatus 200. Then, the viewing apparatus 200 may display the received avatar image group in the avatar setting screen together with a UI component for allowing selection of a desired avatar image (that is, causing a user of the viewing apparatus 200 to decide his/her avatar image) from the avatar image group.

The house information table may include a field indicating a main color of an icon image (an image of an icon representing a building). In this case, a house setting screen displayed upon pressing of a “house setting” button may be configured so that by inputting a character string which indicates a color and pressing a search button, an icon image that has the color as a main color is able to be searched for from all icon images.

That is, when the search button is pressed in the viewing apparatus 200, the group-viewing assistance server 100 may specify a target icon image group by referring to the house information table and transmit the specified icon image group to the viewing apparatus 200. Then, the viewing apparatus 200 may display the received icon image group in the house setting screen together with a UI component for allowing selection of a desired icon image (that is, causing a user of the viewing apparatus 200 to decide an icon indicating a house of the user to be displayed in the virtual world) from the icon image group.

### (Additional Matter 6)

A friend setting screen displayed upon pressing of a “friend setting” button may be configured so that by inputting a keyword and pressing a search button, a user having a nickname matching the keyword is able to be searched for from all users.

That is, when the search button is pressed in the viewing apparatus 200, the group-viewing assistance server 100 may specify a target user group by referring to the user information table and transmit information indicating nicknames of specified users to the viewing apparatus 200. Then, the viewing apparatus 200 may display the nicknames of the users, which are indicated by the information, in the friend setting screen together with a UI component for allowing selection of a nickname of a user desired to be a friend from the nicknames.

Similarly, a community setting screen displayed upon pressing of a “community setting” button may be configured so that by inputting a keyword and pressing a search button, a community having a name matching the keyword is able to be searched for from all communities.

That is, when the search button is pressed in the viewing apparatus 200, the group-viewing assistance server 100 may specify a target community group by referring to the community information table and transmit information indicating names of specified communities to the viewing apparatus 200. Then, the viewing apparatus 200 may display the names of the communities, which are indicated by the information, in the community setting screen together with a UI component for allowing selection of a community desired to be participated in from the communities.

### (Advantage of Group-Viewing Assistance Server 100)

It can be said as follows on the basis of the description above.

That is, the group-viewing assistance server 100 is a group-viewing assistance device that provides a group-viewing service by which remote communication in a group is realized while a common content is viewed by individual viewing apparatuses.

The group-viewing assistance server 100 includes the screen data transmission processing unit 122 and the DB update processing unit 123.

The screen data transmission processing unit 122 (information presentation means) presents, to the viewing apparatus 200 of Mr. B, a viewing environment list that indicates, for each group, which content is under group-viewing.

The screen data transmission processing unit 122 and the DB update processing unit 123 (execution means) execute processing (for example, transmission of data of the house screen of Ms. A to the viewing apparatus 200 of Mr. B by the screen data transmission processing unit 122, and update of the viewing environment information table by the DB update processing unit 123) for making Mr. B participate in remote communication in a group (for example, a group to which Ms. A belongs) designated by Mr. B.

The screen data transmission processing unit 122 (reproduction control means) causes the viewing apparatus 200 of Mr. B to reproduce the content under group-viewing by the group (for example, the group to which Ms. A belongs) designated by Mr. B.

With the aforementioned configuration, only by performing an operation of designating the group, Mr. B is able to simultaneously start viewing of the content under viewing by the group and the remote communication with the group.

Accordingly, it may be said that the group-viewing assistance server 100 allows a viewer to perform group-viewing without giving much resistance.

### (Advantage of Viewing Apparatus 200)

As described above, the viewing apparatus 200 corresponding to the group-viewing service includes the application processing unit 221 and the operation reception unit 250.

The application processing unit 221 (information presentation means) presents a virtual map screen (a viewing environment list that indicates, for each group, which content is under group-viewing) on the display unit 260.

The operation reception unit 250 receives designation of a group from a user while the virtual map screen is displayed.

Being triggered by the designation of the group, the application processing unit 221 (execution means) executes processing (for example, processing for waiting for input of a character string indicating a speech content by the user) for making the user participate in remote communication in the designated group.

Being triggered by the designation of the group, the application processing unit 221 (reproduction means) reproduces the content under group-viewing by the designated group.

With the aforementioned configuration, it may be said that the viewing apparatus 200 also allows a viewer to perform group-viewing without giving much resistance.

### Embodiment 2

A system according to another embodiment of the invention will be described below. Note that, for convenience of description, the members having the same function as those of the members described in Embodiment 1 will be denoted with the same reference signs and description thereof will be basically omitted.

A configuration of the system according to the present embodiment has a similar configuration to that of the system according to Embodiment 1.

Each of viewing apparatuses 200 of users includes a function of registering information (visit information) indicating a frequently visited building in the virtual world. A user information table of the group-viewing assistance server 100 includes a field for holding such visit information.

The system according to the present embodiment is characterized by an operation when the viewing apparatus 200 of Mr. B on which the My House screen is displayed receives an operation of moving a mouse cursor onto a channel selection tab and an operation when the viewing apparatus 200 of Mr. B receives an operation of clicking a selection tab.

That is, in the viewing apparatus 200 of Mr. B, when the operation reception unit 250 receives the operation of moving the mouse cursor, the application processing unit 221 acquires visit information of Mr. B and a viewing environment list from the group-viewing assistance server 100. On the basis of the visit information of Mr. B and the viewing environment list, the application processing unit 221 determines, for each of buildings that the character of Mr. B frequently visits, whether an individual or a group that has been already viewing a content of a channel corresponding to the channel selection tab exists in the building.

Then, as to the building where an individual or a group that has been already viewing the content of the channel corresponding to the channel selection tab exists, the application processing unit 221 of the viewing apparatus 200 of Mr. B displays, near the channel lection tab, information for specifying a manager of the building. Specifically, each time a fixed time has lapsed, the application processing unit 221 switches the information displayed near the channel selection tab from information for specifying a manager of a certain building to information for specifying a manager of a different building.

When the operation reception unit 250 receives an operation of clicking a channel selection tab while information of a manager of a certain building is displayed near the channel selection tab, the application processing unit 221 deletes the My House screen of Mr. B and displays a house screen of the manager of the certain building.

That is, in the present embodiment, Mr. B is able to participate in group-viewing in another person's house that he frequently visits in the virtual world without displaying a virtual map screen.

### Embodiment 3

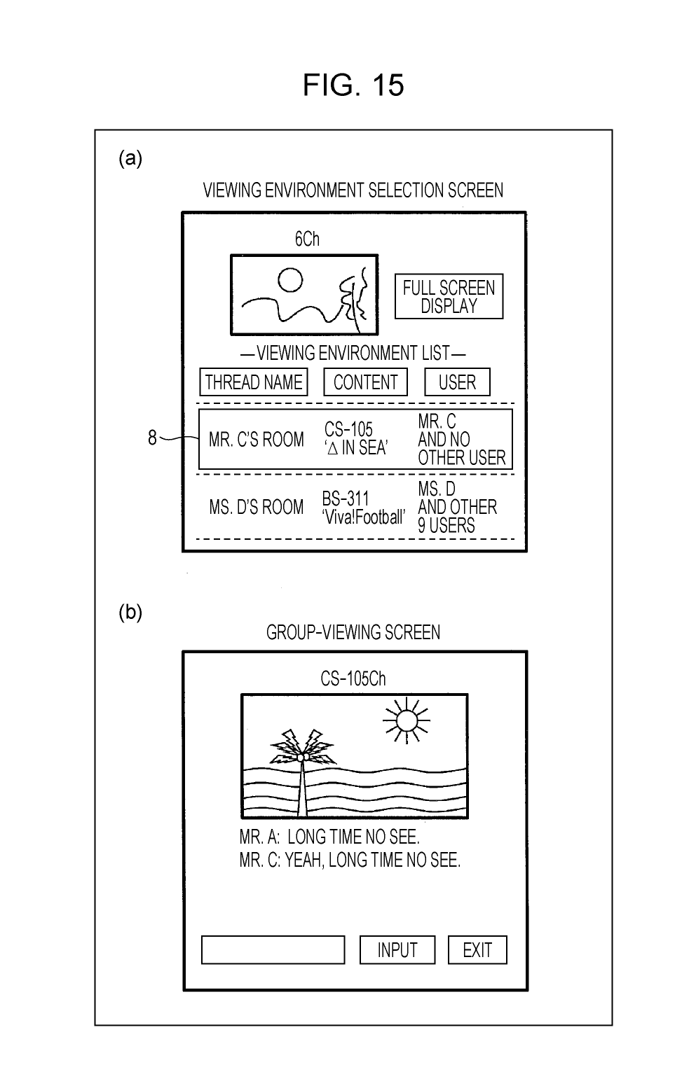

A system according to a still another embodiment of the invention will be described below further with reference to FIG. 15. FIG. 15 illustrates a screen displayed on a viewing apparatus forming the system according to the present embodiment. Note that, for convenience of description, the members having the same function as those of the members described in Embodiment 1 will be denoted with the same reference signs and description thereof will be basically omitted.

The system according to the present embodiment has a similar configuration to that of the system according to Embodiment 1.

On the other hand, differently from Embodiments 1 and 2, a group-viewing application installed on the viewing apparatus 200 according to the present embodiment does not have a function of displaying a virtual map screen and the group-viewing assistance server 100 according to the present embodiment is configured so as not to hold data of a virtual map screen.

Further, differently from Embodiments 1 and 2, a group-viewing service according to the present embodiment provides a function for a registered user to create a chat room a manager of which is the registered user. A chat screen is displayed on a viewing apparatus 200 of a user who has entered the chat room.

In particular, while the user who has created the chat room is in the chat room, the reproduction unit 223 in each of viewing apparatuses 200 of users in the chat room reproduces a content viewed by the user who has created the chat room. Then, the application processing unit 221 in each of the viewing apparatuses 200 of the users displays a video of the reproduced content on the chat screen.

An operation of the system according to the present embodiment will be described more specifically below with an example in which while Mr. C is in a chat room created by himself, Mr. A enters the chat room.

When the viewing apparatus 200 of Mr. A starts the group-viewing application, the application processing unit 221 acquires data of a viewing environment selection screen as illustrated in FIG. 15(a) from the group-viewing assistance server 100 and displays the viewing environment selection screen on the display unit 260. A viewing environment list in the viewing environment selection screen is a list of a chat room as described above (a chat room in which a manager is).

When the operation reception unit 250 receives an operation of selecting a certain element (for example, a top element 8) from the viewing environment list, the application processing unit 221 requests the group viewing assistance server 100 to transmit data of a chat screen in which chatting with Mr. C is able to be performed.

In the group-viewing assistance server 100 having received the request, the screen data transmission processing unit 122 transmits, to the viewing apparatus 200 of Mr. A, data (HTML data) of the chat screen in which chatting with Mr. C is able to be performed. The HTML data includes a script for causing the viewing apparatus 200 of Mr. A to perform execution and the script includes a command for causing the viewing apparatus 200 of Mr. A to select a content (program) reproduced by the viewing apparatus 200 of Mr. C.

In the viewing apparatus 200 of Mr. A having received the data of the chat screen in which chatting with Mr. C is able to be performed, the application processing unit 221 performs display processing of the chat screen. The display processing also includes processing for instructing the channel selection processing unit 222 to select the content reproduced by the viewing apparatus 200 of Mr. C in accordance with the command included in the script and processing for displaying the content which is started to be reproduced by the reproduction unit 223 in a region designated by the HTML data.

As described above, Mr. A is able to participate in group-viewing by a simpler operation in the present embodiment.

### (Additional Matter 7)

The viewing apparatus 200 according to Embodiments 1 to 3 may be a television receiver, a tablet terminal, a smartphone, a feature phone, or other apparatuses. The viewing apparatus 200 may include a touch panel display unit instead of including the operation reception unit 250 and the display unit 260.

In this case, the invention according to Embodiments 1 to 3 may be implemented on the basis of description in which “click” in the description of Embodiments 1 to 3 is replaced with “tap”. The invention according to Embodiment 2 may be implemented on the basis of description in which “the operation of moving a mouse cursor onto a channel selection tab” in the description of Embodiment 2 is replaced with “an operation of touching, with his/her finger, a region where a channel selection tab is displayed in the touch panel display unit”.

The viewing apparatus 200 may be configured to receive an operation by a remote controller. In this case, the invention according to Embodiments 1 to 3 may be implemented on the basis of description in which the operation of clicking any object in the description of Embodiments 1 to 3 is replaced with “an operation of pressing a determination button of the remote controller in a state where a cursor is moved to a position indicating an object”. The invention according to Embodiment 2 may be implemented on the basis of description in which “the operation of moving a mouse cursor onto a channel selection tab” in the description of Embodiment 2 is replaced with “an operation of moving a cursor to a position indicating a selection tab by using a cross key of the remote controller”.

### (Additional Matter 8)

In Embodiments 1 and 2, a building icon in a surrounding map image may be displayed in a display form (for example, a display color) according to a content subjected to group-viewing in a corresponding building. Attached information may be displayed around the building icon in the surrounding map image. For example, the attached information may be information indicating degree of climax of communication in a group in the corresponding building or information indicating that the group in the corresponding building is formed by a large number of users. Note that, the attached information may be generated by the group-viewing assistance server 100 and transmitted to the viewing apparatus 200, or may be generated by the viewing apparatus 200 itself. A user may be allowed to designate what type of attached information is to be displayed.

An avatar image of a different user in the surrounding map image may be displayed in different display forms between a case where the different user is a fried and a case where the different user is not a friend.

### (Additional Matter 9)

In each of the virtual map screens of Embodiments 1 and 2, near a house of a user in the virtual world, a link button (or a link icon) to a screen for a community a manager of which is the user may be arranged. For each of other members belonging to the community, an icon of moving means (for example, an airplane) for instantly moving to a place near a house of the member (or a place where the member is) in the virtual world may be arranged near the link button.

Further, in each of the My House screens of Embodiments 1 and 2, for each of communities to which a user belongs, an icon of moving means (for example, an airplane) for instantly moving to a place near a house of a manager of the community in the virtual world may be arranged.

### (Additional Matter 10)

The group-viewing management server 100 may have a function of arranging an advertisement image in the virtual world. The group-viewing management server 100 may record a movement history in the virtual world of a character of each of users using the group-viewing service. The group-viewing management server 100 may be configured to, for each of areas in the virtual world, specify the cumulative number of users visiting the area in a past fixed time period on the basis of the movement history of the user.

In this case, a provider providing the group-viewing service is able to do business demanding relatively higher advertising fees to a sponsor who desires putting an advertisement image in an area in which the cumulative number of visitors is relatively great.

In the group-viewing service, a user may purchase his/her avatar image and his/her building icon. In this case, the group-viewing management server 100 may sell an avatar image and a building icon which are more popular (that is, used by more users) at higher prices. That is, the group-viewing management server 100 may automatically set a price of the avatar image (or the building icon) in accordance with the number of users of the avatar image (or the building icon).

### (Additional Matter 11)

Each character of users may be allowed to move only along a road on the virtual map. In this case, the group-viewing management server 100 may present, on a virtual map screen of a certain user, a recommended movement route to a place (or a house) where a character of a different user designated by the user is. Note that, the group-viewing management server 100 may present the recommended movement route by using a general route search algorithm (Dijkstra method or the like). When width of the road on the virtual map is not fixed, a value according to both length and width of each road may be used as a weighted value in the Dijkstra method.

### (Additional Matter 12)

The group-viewing management server 100 may manage viewing histories of users using the group-viewing service and specify preferences of the users.

Then, the group-viewing management server 100 may highlight a specific building icon and/or a specific avatar image in a virtual map screen of a certain user. The specific building icon is an icon of a building managed by a different user who has a similar preference to that of the certain user. The specific avatar image is an avatar image of a different user who has a similar preference to that of the certain user.

### (Program and Others)

Control blocks (particularly, the screen data transmission processing unit 122 and the DB update processing unit 123) of the devices (the group-viewing assistance server 100 and the viewing apparatus 200) of Embodiments 1 to 3 may be realized by a logical circuit (hardware) formed in an integrated circuit (IC chip) or the like, or may be realized by software by using a CPU (Central Processing Unit).

In the latter case, each of the devices includes a CPU that executes a command of a program serving as software realizing each function, a ROM (Read Only Memory) or a storage device (which are referred to as a “recording medium”) in which the program and various data are recorded to be readable by a computer (or a CPU), a RAM (Random Access Memory) in which the program is developed, and the like. The object of the invention is achieved when the computer (or the CPU) reads the program from the recording medium for execution. As the recording medium, a “non-transitory tangible medium”, for example, such as a tape, a disc, a card, a semiconductor memory, or a programmable logical circuit is able to be used. The program may be supplied to the computer via any transmission medium (such as a communication network or a broadcast wave) that is able to transmit the program. Note that, the invention may be realized also in a form of a data signal embedded in a carrier wave in which the program is provided by electronic transmission.

### [Overview]

A group-viewing assistance device (for example, the group-viewing assistance server 100) according to an aspect 1 of the invention is a group-viewing assistance device that provides a group-viewing service by which remote communication in a group is realized while a common content is viewed by individual viewing apparatuses, including: information presentation means (for example, the screen data transmission processing unit 122) that presents, to a viewing apparatus (for example, the viewing apparatus 200) of a user (for example, Mr. B), information (for example, a viewing environment list) indicating, for each group, which content is under group-viewing; execution means (for example, the screen data transmission processing 122 and the DB update processing unit 123) that executes processing for causing the user to participate in remote communication in a group (for example, a group to which Ms. A belongs) designated by the user; and reproduction control means (for example, the screen data transmission processing unit 122) that controls the viewing apparatus of the user to reproduce a content under group-viewing by the designated group.

With the aforementioned configuration, only by performing an operation of designating the group, the user is able to simultaneously start viewing of the content under group-viewing by the group and the remote communication with the group.

Accordingly, it may be said that the group-viewing assistance device allows a viewer to perform group-viewing without giving much resistance.

The group-viewing assistance device according to an aspect 2 of the invention may be configured so that in the aspect 1, the group is linked to any point in a virtual world (for example, a house managed by Ms. A in the virtual world) in which characters of users are able to move, image presentation means (for example, the screen update information transmission processing unit 124) that presents, to the viewing apparatus of the user (for example, Mr. B), an image (for example, a range around a character of Mr. B) that indicates a partial range including a point at which a character corresponding to the user exists in the virtual world is included, and information presented by the information presentation means is information indicating, for each group linked to the point in the range, which content is under group-viewing.

With the aforementioned configuration, an information quantity of the information presented by the information presentation means does not increase so much. Accordingly, the group-viewing assistance device further exerts an effect of allowing the user to designate the group without confusing the user as to which group is to be designated.

The group-viewing assistance device according to an aspect 3 of the invention may be configured so that in the aspect 2, an operation of designating a group (for example, a group to which Ms. A belongs) by the user is an operation of moving the character corresponding to the user to a point (for example, a house managed by Ms. A in the virtual world) linked to the group in the virtual world.

With the aforementioned configuration, the group-viewing assistance device further exerts an effect of allowing the user to participate in group-viewing as if the user plays a game.

The group-viewing assistance device according to an aspect 4 of the invention may be configured so that in the aspect 2 or the aspect 3, the information presentation means is configured to present the information in a list format, an operation of selecting an element corresponding to a group from a list indicating the information is the operation of designating the group, and a group corresponding to an element closer to a top in the list is a group linked to a point at a closer distance from the character corresponding to the user.

With the aforementioned configuration, the group-viewing assistance device further exerts an effect of allowing the user to participate in group-viewing with an easier operation.

The group-viewing assistance device according to an aspect 5 of the invention may be configured so that in any of the aspect 2 to the aspect 4, objects representing houses of users are arranged in the virtual world, information presentation means that presents, to the viewing apparatus of the user, information about a position at which an object representing a house of a different user is arranged is included, and the information presentation means presents the information in a case where an operation of moving the character corresponding to the user to a point at which a character corresponding to the different user exists is performed.

With the aforementioned configuration, the group-viewing assistance device further exerts an effect of allowing the user to perform group-viewing more easily with a different user newly met in the virtual world.

The group-viewing assistance device according to an aspect 6 of the invention may be configured so that in any of the aspect 1 to the aspect 3, the information presentation means is configured to present the information in a list format, and an operation of selecting an element corresponding to a group from a list indicating the information is the operation of designating the group.

With the aforementioned configuration, the group-viewing assistance device further exerts an effect of allowing the user to participate in group-viewing with an easier operation.

A group-viewing assistance method according to an aspect 7 of the invention is a group-viewing assistance method by one or a plurality of devices used for providing a group-viewing service by which remote communication in a group is realized while a common content is viewed by individual viewing apparatuses, including the steps of: presenting, to a viewing apparatus of a user, information indicating, for each group, which content is under group-viewing; executing processing for causing the user to participate in remote communication in a group designated by the user; and controlling the viewing apparatus of the user to reproduce a content under group-viewing by the designated group.

With the aforementioned configuration, the group-viewing assistance method exerts a similar working effect to that of the group-viewing assistance device according to the aspect 1.

A viewing apparatus (for example, the viewing apparatus 200) according to an aspect 8 of the invention is a viewing apparatus that supports a group-viewing service which is a service provided by a group-viewing assistance device and by which remote communication in a group is realized while a common content is viewed by individual viewing apparatuses, including: information presentation means (for example, the application processing unit 221) that presents information indicating, for each group, which content is under group-viewing; a reception unit (for example, the operation reception unit 250) that receives designation of a group from a user; execution means (for example, the application processing unit 221) that executes processing, with the designation as a trigger, for causing the user to participate in remote communication in the designated group; and reproduction means (for example, the application processing unit 221) that reproduces a content under group-viewing by the designated group with the designation as a trigger.

With the aforementioned configuration, the viewing apparatus according to the aspect 8 of the invention exerts a similar working effect to that of the group-viewing assistance device according to the aspect 1.

The group-viewing assistance device according to each of the aspects 1 to 6 of the invention may be realized by a computer, and in such a case, a program which causes the computer to operate as each of the means of the group-viewing assistance device to thereby realize the means by the computer, and a computer-readable recording medium having the program recorded therein are also included in the scope of the invention.

The invention is not limited to each of the embodiments described above, and can be modified in various manners within the scope defined by the Claims, and embodiments obtained by appropriately combining technical means disclosed in different embodiments are also encompassed by the technical scope of the invention. A new technical feature can be formed by combining technical means disclosed in each of the embodiments.

### INDUSTRIAL APPLICABILITY

The invention is suitably used in a field related to terrestrial digital broadcasting.

### REFERENCE SIGNS LIST

100 group-viewing assistance server (group-viewing assistance device)
120 control unit
121 reception data analysis unit
122 screen data transmission processing unit (information presentation means, reproduction control means, execution means)
123 DB update processing unit (execution means)
124 screen update information transmission processing unit (image presentation means, information presentation means)

1. A group-viewing assistance device that provides a group-viewing service by which remote communication in a group is realized while a common content is viewed by individual viewing apparatuses, the group-viewing assistance device comprising:
information presentation circuitry that presents, to a viewing apparatus of a user, information indicating, for each group, which content is under group-viewing;
execution circuitry that executes processing for causing the user to participate in remote communication in a group designated by the user; and
reproduction control circuitry that controls the viewing apparatus of the user to reproduce a content under group-viewing by the designated group.

2. The group-viewing assistance device according to claim 1, wherein
the group is linked to any point in a virtual world in which characters of users are able to move,
image presentation circuitry that presents, to the viewing apparatus of the user, an image that indicates a partial range including a point at which a character corresponding to the user exists in the virtual world is included, and
information presented by the information presentation circuitry is information indicating, for each group linked to the point in the range, which content is under group-viewing.

3. The group-viewing assistance device according to claim 2, wherein an operation of designating a group by the user is an operation of moving the character corresponding to the user to a point linked to the group in the virtual world.

4. The group-viewing assistance device according to claim 2, wherein
the information presentation circuitry is configured to present the information in a list format,
an operation of selecting an element corresponding to a group from a list indicating the information is the operation of designating the group, and
a group corresponding to an element closer to a top in the list is a group linked to a point at a closer distance from the character corresponding to the user.

5. The group-viewing assistance device according to claim 2, wherein
objects representing houses of users are arranged in the virtual world,
information presentation circuitry that presents, to the viewing apparatus of the user, information about a position at which an object representing a house of a different user is arranged is included, and
the information presentation circuitry presents the information in a case where an operation of moving the character corresponding to the user to a point at which a character corresponding to the different user exists is performed.

6. The group-viewing assistance device according to claim 1, wherein
the information presentation circuitry is configured to present the information in a list format, and
an operation of selecting an element corresponding to a group from a list indicating the information is the operation of designating the group.

7. A group-viewing assistance method by one or a plurality of devices used for providing a group-viewing service by which remote communication in a group is realized while a common content is viewed by individual viewing apparatuses, the group-viewing assistance method comprising the steps of:
presenting, to a viewing apparatus of a user, information indicating, for each group, which content is under group-viewing;
executing processing for causing the user to participate in remote communication in a group designated by the user; and
controlling the viewing apparatus of the user to reproduce a content under group-viewing by the designated group.

8. A viewing apparatus that supports a group-viewing service which is a service provided by a group-viewing assistance device and by which remote communication in a group is realized while a common content is viewed by individual viewing apparatuses, the viewing apparatus comprising:
information presentation circuitry that presents information indicating, for each group, which content is under group-viewing;
reception circuitry that receives designation of a group from a user;
execution circuitry that executes processing, with the designation as a trigger, for causing the user to participate in remote communication in the designated group; and
reproduction circuitry that reproduces a content under group-viewing by the designated group with the designation as a trigger.
